(19) United States
(12) Patent Application Publication
(10) Pub. No.: US 2026/0181322 A1
(43) Pub. Date: Jun. 25, 2026

(54) METHOD FOR THE DIRECTION-DEPENDENT CORRECTION OF THE FREQUENCY RESPONSE OF SOUND WAVEFRONTS

(71) Applicant: HOLOPLOT GMBH, Berlin (DE)

(72) Inventors: Evert W. START, Zeist (NL); Adrian LARA MORENO, Benalmadena (ES)

(73) Assignee: HOLOPLOT GMBH, Berlin (DE)

(21) Appl. No.: 19/125,873

(22) PCT Filed: Oct. 19, 2023
(86) PCT No.: PCT/EP2023/079178

§ 371 Date: Apr. 30, 2025

(30) Foreign Application Priority Data
Nov. 9, 2022 (DE) 10 2022 129 642.3

(51) Int. Cl. H04R 3/04

(52) U.S. Cl. CPC H04R 3/04; H04R 2201/401

(57) ABSTRACT

The invention relates to a method for operating and/or setting up a two-dimensional sound transducer assembly (1) comprising a plurality of discretely controllable sound transducers (9), wherein the sound transducers (9) of the sound transducer assembly (1) each generate elementary waves which are superposed wavefrontaccording to the principle of wave field synthesis and/or according to beamforming methods to form at least one sound wavefront, wherein a local propagation direction for the at least one sound wavefront is known or can be determined at each transducer (9) of the transducer assembly (1). At least one acoustic disturbance factor which causes frequency-dependent and/or direction-dependent variations in the sound pressure of at least one first sound transducer (9) of the sound transducer assembly (1) is detected, and an input signal of the at least one first sound transducer (9) of the sound transducer assembly (1) is detected, and an input signal of the at least one first sound transducer (9) of the sound transducer assembly (1) is coupled to at least one correction device, in particular a filter device, which influences the acoustic disturbance factor depending on the local propagation direction of the at least one sound wavefront at the at least one first sound transducer (9), in particular by minimizing it by means of a forward correction.

The proposed solution describes a method for the direction-dependent correction of the frequency response of sound wavefronts which are generated in two-dimensional sound transducer assemblies according to the principle of wave field synthesis or according to beamforming methods.

With a plurality of discretely controlled sound transducers, it is possible to radiate several acoustic wavefronts simultaneously in different directions. A vector-based method, as is known from German Patent Application DE 10 2021 207 302 A1, adapts the shape and level of each of the wavefronts generated from a plurality of elementary waves to the spectator area such that hardly any undesired reflections of the reproduction space are excited even under unfavorable acoustic conditions. This results in an exceptionally high speech intelligibility in the entire spectator area. In addition, the signal levels are adapted by the described method so that a very balanced sound pressure level is achieved in the entire spectator area, even if its shape is irregular and the distances of the listeners from the sound transducer surface vary very greatly.

For this purpose, the delay times and levels for each individual one of the sound transducers of the sound transducer assembly and each individual wavefront are calculated separately. A mathematical method for calculating the delay times is described, for example, in patent application DE 10 2021 207 302 A1. In one embodiment, each sound transducer of the sound transducer assembly is associated with coordinates in the spectator area. A vector calculation of the distances between the sound transducer and the associated point in the spectator area results, with corresponding correction of the level, in the very uniform sound pressure distribution in the spectator area for each individual one of the input signals.

According to the principle of wave field synthesis (A. J.Berkhout, A Holographic Approach to Acoustic Control, J.Audio Eng.Soc, Vol. 36, No. 12, 1988), a plurality of sound transducers generates a wavefront which supplies a given audience area with a very uniform level of high audio quality without undesirably radiating adjacent reflection surfaces too much.

With the growing dimension of the audience areas of major events, the demands on the sound systems are increasing. Often, the differences in sound pressure between the individual spectator stations are not tolerable in the case of a low-directional radiation of the sound waves, reproduction, frequency response and speech intelligibility suffer from a level drop, airborne sound insulation and undesired reflections.

For this reason, speaker assemblies from several individual sound sources direct the sound more strongly into the more distant audience areas. A typical application are so-called line arrays, which are arranged, for example, on the left and right above a stage front. Its curvature is adapted to the audience area such that the radiated wavefront in the elevation plane is oriented to the more distant audience areas. Almost a cylinder wave is generated around this part of the speaker assembly.

The surface of a cylinder grows linearly with its radius, which is why the sound pressure decreases by 3 decibels with each distance doubling.

In the lower area of the sound transducer assembly, the greater curvature of the transducer surfaces causes a greater vertical opening angle. In this area, the wavefront is almost a spherical segment. Here, the surface of a sphere, which grows square with the radius, causes a sound pressure drop of 6 dB with each distance doubling. Due to the rapid sound pressure drop in the vicinity and the wider cylinder shaft for the distant places, the differences in sound pressure between the front and rear audience areas are significantly reduced.

In recent years, sound lines with electronic control of the individual sound transducers have also been employed. Each sound transducer has its own amplifier, which is controlled by a signal processor. Mathematical methods permit radiation which is significantly better adapted to the audience area than would be possible with the mechanical alignment of individual sound transducers. The curvature of the sound transducer assembly can be simulated and electronically adapted in accordance with Huygen's principle with small delays in the control of the individual transducers. However, with the available sound lines, these possibilities are limited to the elevation plane.

Since the directional characteristic can also be adapted with this improved radiation only in the elevation plane, the sound field remains only roughly tailored to the given audience area. In the azimuth plane, the radiation is only given by the mechanical alignment of the speaker group. Here, it is possible at most to adapt to the audience area by selecting speaker elements with a wider or narrower horizontal directional characteristic.

Speaker fields, such as those available for audio reproduction according to the principle of wave field synthesis (as in WO2015036845A1, for example), are much more flexible. Here, each sound transducer is operated on a separate final amplifier. In accordance with Huygen's principle, a wavefront is composed of the superposition of the elementary waves of each individual sound transducer, which reconstructs a spherical segment of the wavefront of a real sound source. The center of this spherical segment is the virtual sound source of wave field synthesis. The limits of the spherical segment are determined by the size of the sound transducer field in connection with the position of the virtual sound source.

The individual sound transducers of the at least one sound transducer assembly radiate—during operation—elementary waves, which are superposed to form a common wavefront. Whenever in the following reference is made to the radiation of elementary waves from the sound transducers, the acoustic center of the sound transducers is meant.

The at least one sound transducer assembly and the audience area are associated with a common coordinate system, in particular a Cartesian coordinate system.

As will become clear in the following, the coordinate system on the side of the at least one sound transducer assembly serves in particular to provide starting points for position vectors sᵢ which together with direction vectors rᵢ determine the radiation of the sound from the at least one sound transducer assembly. The coordinate system thus links the at least one sound transducer assembly and the at least one audience area.

There is a spatial association between the position vectors sᵢ and the physical positions of the transducers. In the simplest case, the acoustic centers of the sound transducers are located at the place of origin of the position vectors sᵢ. However, it is also possible for the sound transducers to not lie exactly at the places of origin of the position vectors sᵢ. If the positions of the acoustic centers of the sound transducers deviate from the intersection points of the auxiliary grid, the change in delay time and level connected thereto can be corrected by spatial interpolation or other methods. The position vectors sᵢ can be stored in the form of a list, for example.

By introducing the coordinate system, points in the audience area and points on the at least one sound transducer assembly—and thus indirectly also the sound transducers themselves—can be simply geometrically related to one another, as for example in the calculation of a distance of a sound transducer to a point in the audience area.

The method proceeds from an association of points of the coordinate system to points in at least one audience area and associates a position vector r accordingly. The position vector rᵢ thus points to a specific location in the audience area 3.

From the position vectors sᵢ, from which the positions of the individual sound transducers can be determined indirectly or also directly, direction vectors, in particular standardized direction vectors

$${\hat{d}}_{i} = \frac{{r}_{i} - {s}_{i}}{\vert {r}_{i} - {s}_{i} \vert} ,$$

can be determined which determine the radiation direction of the wavefront in the area of the respective sound transducers.

Now, depending on the spatial association of the position vectors sᵢ and the sound transducers delay times τⱼ for the transducers are determined, with which acoustic elementary waves are then radiated. The delay times τⱼ of the sound transducers are in each case chosen such that the local direction of the common wavefront corresponds to the direction of the direction vector, in particular of the standardized direction vector \hat{d}₁.

The sound transducers of the at least one sound transducer assembly are thus each operated with a specific delay time τⱼ. The delay time τⱼ of a sound transducer determines the time of generation of an elementary wave at the corresponding sound transducer. In particular, the delay times τⱼ of the individual sound transducers can be determined with respect to the input signal. In other words, each sound transducer is assigned an individual delay timer τⱼ. The delay times of the individual sound transducers may differ fundamentally, but some sound transducers can also be operated with the same delay timerτ₁.

The totality of the delay times with which the individual sound transducers of the sound transducer assembly are operated influences the shape of the common wavefront, which is composed of the elementary waves generated by the individual sound transducers. In particular, the shape of the common wavefront can be determined by the totality of the delay times τⱼ.

In particular, complex wavefronts can be generated by certain choices of the delay timesτⱼ. As a result, a correspondingly shaped wavefront, for example with different curvatures, results from different delay times τⱼ in the sound transducer assembly. The wavefront formed by the elementary waves is no longer a spherical segment as it is generated by a virtual sound source with a two-dimensional wave field synthesis sound transducer assembly. Depending on the shape and size of the supply area (i.e. of the at least one audience area), there are stronger curvatures and flatter curved areas. In the direction of the far away spectator places, the convex curvature of the wavefront is usually less, a stronger curvature in the direction of the front spectator places allows the sound pressure level to drop faster with the distance and distributes the energy to a larger spectator area.

The delay times τⱼ of the individual sound transducers can be determined such that the common wavefront adapts to the geometry of the audience area. In particular, the local directions of the wavefront are controlled by the delay times τⱼ. The irregularly shaped wavefront thus created is in principle associated with the same number of grid points (i.e. of the coordinate system in the area of the sound transducer assembly) of the sound transducer assembly and thus also of sound transducers with the same size of the audience area. In this respect, such a wavefront differs fundamentally from the spherical segment of a point-shaped virtual sound source of wave field synthesis, in which the spectator surface supplied by the same number of sound transducers increases continuously with the distance.

The local direction of the common wavefront at a position on the wavefront describes in each case the direction in which the common wavefront propagates at the respective position. The local direction of the common wavefront can in each case be described by the direction vector which is perpendicular to the respective point on the common wavefront. The direction vector describes a local propagation direction of the common wavefront when the wavefront moves perpendicular to the direction vector.

An adaptation of the common wavefront to the geometry of the at least one audience area is made possible by a determinable association which, in each case, associates the position vectors sᵢ (which, for example, can be associated with individual wave transducers) with a position in the audience area corresponding to a position vector rᵢ. Standardized direction vectors

$${\hat{d}}_{i} = \frac{{r}_{i} - {s}_{i}}{\vert {r}_{i} - {s}_{i} \vert}$$

result from the respective association. The delay times τⱼ are then in each case chosen such that the local direction of the common wavefront at the position in the audience area which is described by the position vector rᵢ, corresponds to the direction of the direction vector \hat{d}ᵢ. In particular, local propagation directions of the common wavefront are given by the standardized direction vectors \hat{d}ᵢ.

The sound transducers of the at least one sound transducer assembly can be arranged on or in a plane. Alternatively, the sound transducers of the sound transducer assembly can be arranged on or in an at least partially curved surface. The assembly can be grid-like, for example. In particular, the distances between the sound transducers can be uniform. For example, the distances in a first direction, in particular in the vertical direction, and/or the distances in a second direction, in particular in the horizontal direction, can correspond in each case or result in a regular sequence of distance variables. The geometric shape in or on which the sound transducers are arranged can be complex. For example, the sound transducers can lie in a planar surface in an area, wherein other sound transducers of the same sound transducer assembly lie on a curved surface. Different parts of the surface can also have different radii of curvature.

Alternatively, the sound transducers of the at least one sound transducer assembly are arranged in a three-dimensional area, in particular in a space. The assembly of the individual sound transducers can be determined starting from a reference surface, for example a plane or a curved surface, wherein at least a partial amount of the sound transducers of the at least one sound transducer assembly is arranged on the reference surface and the positions of the remaining sound transducers of the at least one sound transducer assembly can be determined by a spatial offset into the three-dimensional area.

The operation of the sound transducer—which is sᵢ associated with the position vector—with delay time τⱼ can be in each case by a control by means of a computer system. In particular, the control can be digitally influenced with delay time τⱼ or can be effected by a digital control. The delay times can be in the order of magnitude of milliseconds. For adjacent sound transducers, the time difference is usually only a few microseconds, so that the overall system requires a very stable system clock.

Additionally or alternatively, the delay time with which a sound transducer is operated can be influenced mechanically or geometrically. For example, the delay time of a sound transducer can be controlled by means of a spatial offset, in particular in the radiation direction of the sound transducer assembly, with respect to other sound transducers of the sound transducer assembly.

The audience area can have at least partially a planar or concave and/or at least partially a convex shape. The audience area can be described as a continuous area or as a discontinuous area consisting of at least two continuous parts. An example of an audience area composed of several areas is the large hall of the Philharmonic, Berlin or an opera hall with several ranks. However, the audience area can also be represented by a number of coordinate points.

In the coordinate system, the position vectors sᵢ associated with the sound transducers of the sound transducer assembly can result in a regular grid.

Additionally or alternatively, the position vectors rᵢ can result in a regular grid on the reference surface R associated with the audience area.

The association that associates each position vector sᵢ in the sound transducer array with a point in the audience area corresponding to the position vector rᵢ can be determined by means of connecting lines from the sound transducer assembly into the audience area. In particular, the connecting line can be a half-line starting from the position vector sᵢ which cuts the audience area or the reference surface R associated with the audience area. A position vector rᵢ can then be associated with the sound transducer which results from the intersection of the half-line with the audience area or the reference surface R, associated with the audience area.

Additionally or alternatively, the levels at which the sound transducers of the at least one sound transducer assembly are operated can be determined by means of a relative amplification factor, in particular based on the provision \hat{d}ₙ=\hat{d}ᵢ·nᵢ, wherein nᵢ in each case describes the normal to the reference surface S on the position vector sᵢ.

By operating the sound transducers according to the relative amplification factors \hat{d}ₙ, it is ensured that the sound pressure level at the receiver position rᵢ is independent of the angle of the direction vector dᵢ to the normal nᵢ. Thus, a homogeneous volume in the audience area to be sonicated can be ensured.

Further, the proposed solution comprises a method for determining delay times τⱼ for a sound transducer assembly with a plurality of sound transducers j for generating elementary waves according to the delay times τⱼ to sonicate at least one audience area.

The method comprises the steps of determining a coordinate system by means of which the at least one sound transducer assembly is approximately described as a reference surface S and the audience area is approximately described as a reference surface R; determining position vectors s on the reference surface S of the at least one sound transducer assembly, from which the positions of the sound transducers of the at least one sound transducer assembly can be determined; determining standardized direction vectors \hat{d} starting from the position vectors s, wherein the standardized direction vectors \hat{d} are directed to the reference surface R of the audience area and determining delay times τⱼ for sound transducers j, so that the elementary waves of the sound transducers of the sound transducer assembly during operation overlap according to the delay times τⱼ to form a common wavefront, wherein the standardized direction vectors \hat{d} describe local propagation directions of the common wavefront.

In other words, the common wavefront propagates substantially perpendicularly to the standardized direction vectors \hat{d}. In this way, the standardized direction vectors \hat{d} describe the propagation course of the common wavefront. In particular, the common wavefront can be adapted to the geometry of the audience area by suitable choice of the standardized direction vectors \hat{d}.

For an adjustment of the sound levels, the relative amplification factors \hat{d}ₙ for at least a partial amount of the position vectors s can be determined according to the provision

$${\hat{d}}_{n} = \hat{d} \cdot n$$

wherein n is a normal to the reference surface S of the sound transducer assembly at the point determined by the position vector s and \hat{d} is the standardized direction vector starting from the position vector s.

The position vectors s can correspond wholly or partly to the positions of the sound transducers on the sound transducer assembly, in each case there is a spatial association between the physical positions of the individual sound transducers in the at least one sound transducer assembly and the position vectors sᵢ for setting coordinates in the area of the at least one sound transducer assembly.

The number of the position vectors s can correspond to the number of the sound transducers of the sound transducer assembly or can also be different therefrom. In particular, the number of the position vectors s can be higher than the number of the transducers on the sound transducer assembly.

The position vectors s can describe intersection points of an auxiliary grid described on the reference surface S of the at least one sound transducer assembly. However, position vectors s do not have to lie at all intersections of the auxiliary grid. For example, the auxiliary grid can describe a rectangular plane.

The number of the grid lines in the horizontal and/or vertical direction can in each case correspond to a number of rows and/or columns of sound transducers of the sound transducer assembly. But the number of the grid lines in the horizontal and/or vertical direction can also be larger than a number of rows and/or columns of sound transducers of the sound transducer assembly.

The method can further comprise a determination of position vectors r on the reference surface R of the audience area, wherein a position vector r is associated with a position vector s in each case. The association can be made by means of a connecting line from the position vectors s to the position vector r on the basis of which the respective standardized direction vector \hat{d} can be determined. In particular, the direction vector d can be determined in each case by means of the calculation provision

$$\hat{d} = \frac{r - s}{\vert r - s \vert} .$$

In one embodiment, the totality of the connecting lines is such that they do not cross or intersect in pairs. In particular, no connecting line intersects the respective other connecting lines.

The association of the position vectors s with the position vectors r can be automatically, in particular by means of a 3D CAD file of the audience area. This can be done according to a suitable mapping method. In particular, points and/or areas of the reference surface of the audience area can be omitted during the association, for example those which correspond to areas of the audience area which are not to be hit by the common wavefront.

The position vectors r can be uniformly distributed on the reference surface R of the audience area. This allows them to correspond to evenly distributed points in the audience area. A uniform distribution of the points is ensured, for example, by the fact that two adjacent points are each at the same distance from one another.

The reference surface R of the audience area can be described by an auxiliary grid. The position vectors r can at least partially correspond to intersection points of the auxiliary grid.

Likewise, the reference surface S of the sound transducer assembly can be described by an auxiliary grid on which the position vectors s correspond at least partially to intersection points. Such an auxiliary grid is particularly important for numerical treatment, since, for example, numerical integrations can be easily executed therein by means of the trapezoidal rule.

Auxiliary grids on the reference surface S of the at least one sound transducer assembly and auxiliary grids on the reference surface R of the audience area can be converted into one another. In particular, they can have the same number of lines in the horizontal and/or vertical plane. By connecting the intersection points of the auxiliary grids, a suitable connection can be established between the reference plane S of the at least one sound transducer assembly to the reference plane R of the audience area.

The reference surface S of the at least one sound transducer assembly can be a plane or, for example, an at least partially curved surface. In particular, a curvature of the reference surface S of the sound transducer assembly in the horizontal direction can be different from a curvature in the vertical direction.

In one embodiment, the reference surface S of the sound transducer assembly is parameterized by means of coordinates s(u, v)=[x(u, v) y(u, v) z(u, v)], wherein a and v are real, continuous variables.

To determine the respective individual delay times τⱼ for sound transducers j, first, a scalar function of delay times τ(u, v) for a finite amount of position vectors of the form s=s(u, v) can be determined and then the determinations of the delay time τⱼ for sound transducers j can be at least partially by interpolation of at least two values of the form τ(u, v).

The delay times τ(u, v) are determinable in one embodiment by means of numerical integration of the discrete 2D vector field[ΔᵤτΔᵥτ]. The delay differences Δᵤτ are given in the u direction or Δᵥτ in the v direction by

$${Δ}_{u} τ = \frac{{\hat{d}}_{u}}{c} Δ u$$

$$or$$

$${Δ}_{v} τ = \frac{{\hat{d}}_{v}}{c} Δ v ,$$

wherein Δu and Δv each describe discrete increments in the u direction or the v direction, c describes the sound speed and wherein \hat{d}ᵤ and \hat{d}ᵥ are given through the scalar products

$${\hat{d}}_{u} = \hat{d} \cdot {s}_{u}$$

$$or$$

$${\hat{d}}_{v} = \hat{d} \cdot {s}_{v} , ,$$

wherein \hat{d} respectively describes the standardized direction vector starting from the position vector s=s(u, v)and sᵤ and sᵥ describe tangent vectors to the reference surface S starting from the position vector s=s(u, v).

The tangent vectors sᵤ and sᵥ are given by the partial derivatives

$${s}_{u} = \frac{\partial s}{\partial u} = [ \frac{\partial x}{\partial u} \frac{\partial y}{\partial u} \frac{\partial z}{\partial u} ]$$

$$or$$

$${s}_{v} = \frac{\partial s}{\partial v} = [ \frac{\partial x}{\partial u} \frac{\partial y}{\partial u} \frac{\partial z}{\partial u} ] .$$

In other words, in a method for determining the delay times τ(u, v), first, the two-dimensional discrete vector field[ΔᵤτΔᵥτ] according to the provisions

$${Δ}_{u} τ = \frac{{\hat{d}}_{u}}{c} Δ u$$

$$or$$

$${Δ}_{v} τ = \frac{{\hat{d}}_{v}}{c} Δ v ,$$

can be determined on the basis of tangent vectors sᵤ and sᵥ of the reference surface S of the sound transducer assembly, the standardized direction vectors \hat{d} and the sound speedc. The vector field can then be integrated by means of a numerical integration method. The function τ(u, v) obtained by the integration then describes the desired delay times.

The values of the function τ(u, v)describe the delay times at the position vectors s(u, v), s(u, v) defines a separate position sᵢ for every single combination of the parameters u and v. The delays at the driver positions can then be determined by spatial interpolation.

The calculated time is then executed with the time of the closest sample predetermined by the sampling frequency of the overall system.

In particular, the desired delay times are described by a function τ(u, v), the gradient of which has the two-dimensional vector field[ΔᵤτΔᵥτ], wherein the components Δᵤτ and Δᵥτ are as given above. A wavefront can be considered as a kind of relief that associates a height at this location with each intersection point of the grid. The gradient at the location then is a vector pointing in the direction of the greatest elevation. The magnitude of this vector indicates the greatest slope at this point.

The sound speed c can be dependent on the location, if, for example, a higher temperature prevails in a higher area of the sound propagation area, which influences the sound speed. The sound speed can also be dependent on the location, which is then included in the calculation.

The numerical integration method can comprise the composite trapezium method, the Simpson method, the Romberg method or the more advanced inverse gradient method.

If the reference surface S of the sound transducer assembly is parameterized by means of a function s(u, v)=[x(u, v) y(u, v) z(u, v)], as described above, the normal n to the reference surface S of the sound transducer assembly which can be used for the determination of the sound level correction is given at the point described by s=s(u, v) by the cross-product of sᵤ and sᵥ

$$n = {s}_{u} \times {s}_{v} ,$$

wherein

sᵤ and sᵥ are given by the partial derivatives, as described above.

Embodiments are described below by way of example with reference to figures. Wherein

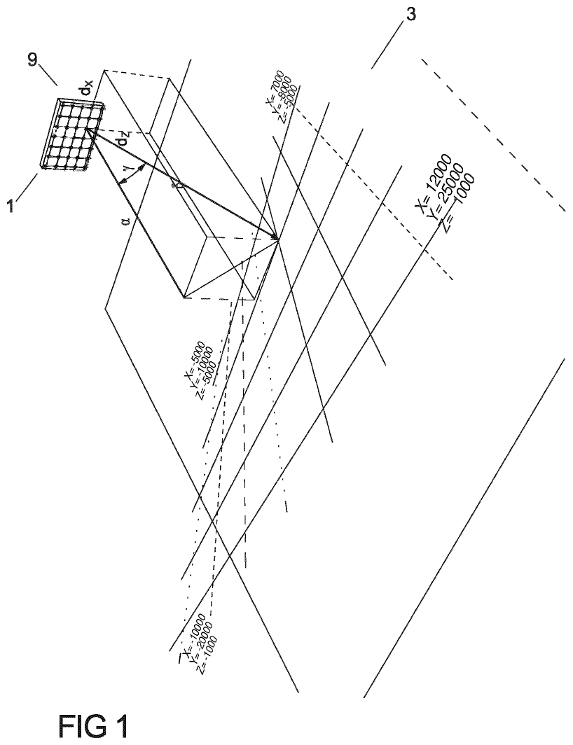

FIG. 1 describes an embodiment for operating a sound transducer assembly;

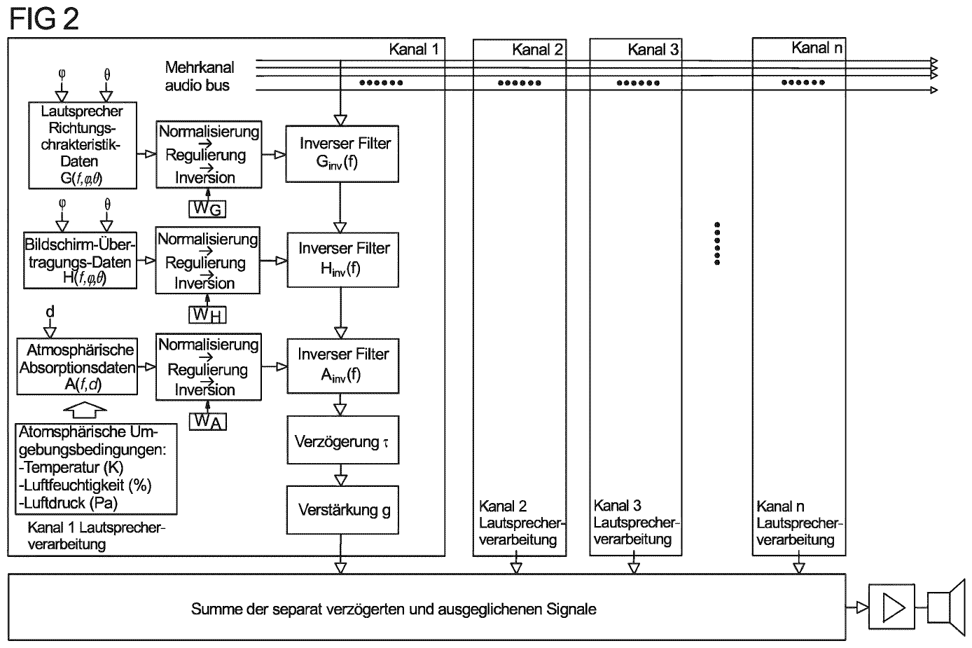

FIG. 2 describes a schematic representation of the method for the direction-dependent correction of the frequency response;

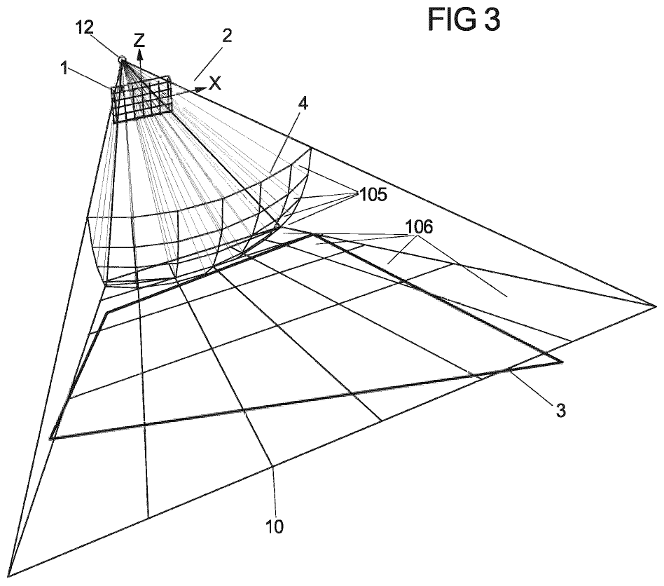

FIG. 3 describes a schematic representation of the wavefront of a virtual sound source of wave field synthesis in a two-dimensional sound transducer assembly;

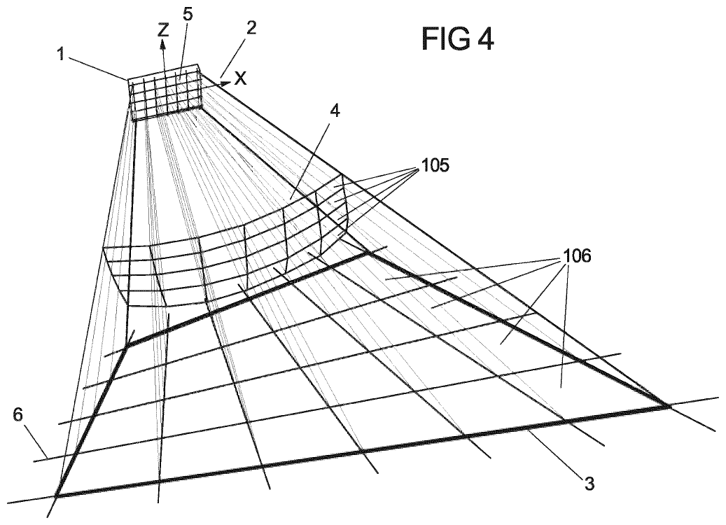

FIG. 4 describes a schematic representation of the wavefront of a shape of the wavefront of a two-dimensional sound transducer assembly adapted to the spectator area;

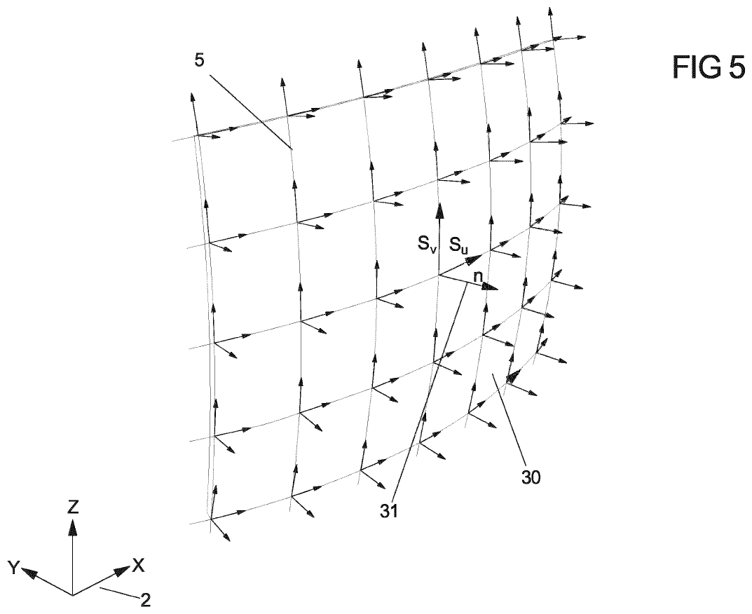

FIG. 5 describes the determination of normal vectors on a curved reference surface of a sound transducer assembly;

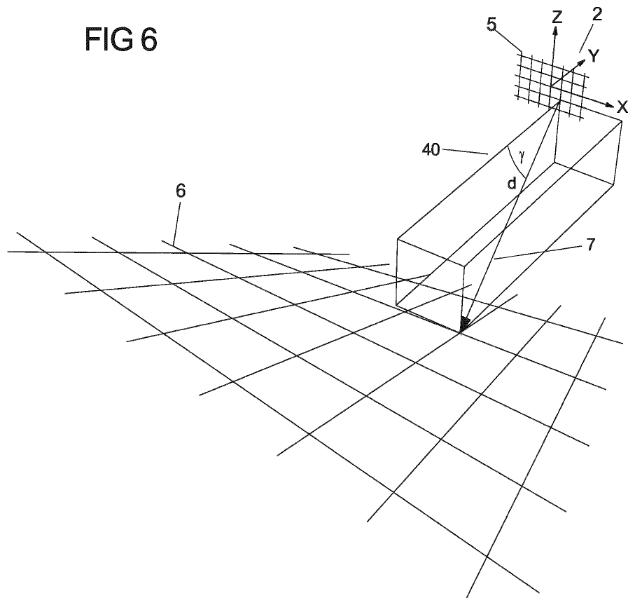

FIG. 6 describes the association of the auxiliary grid of a sound transducer assembly with an auxiliary grid in the audience area;

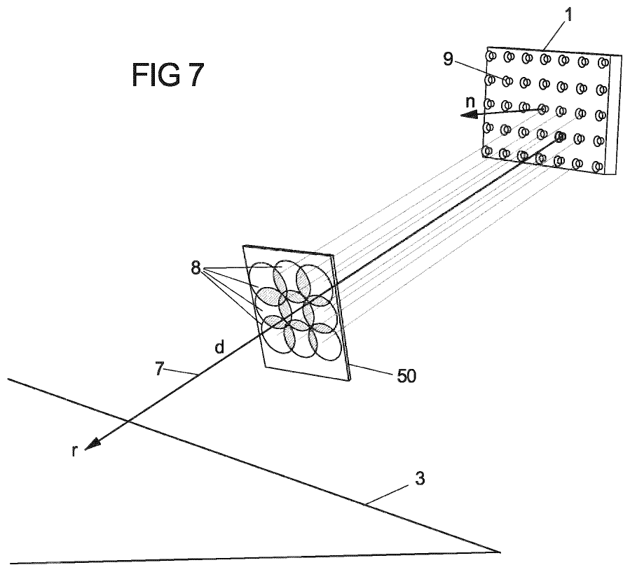

FIG. 7 describes the formation of a local direction vector of the wavefront, which originates starting from a sound transducer from surrounding elementary waves and shows the audience area;

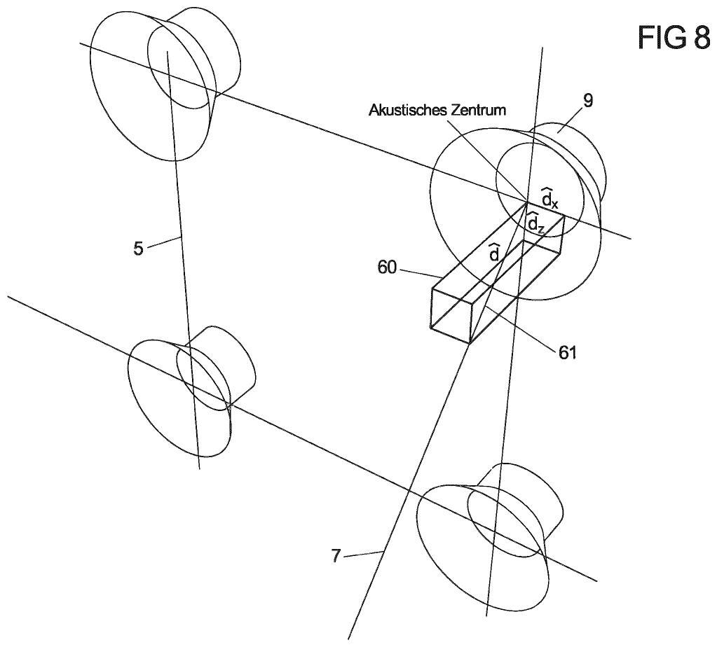

FIG. 8 describes the formation of a standardized direction vector of length one;

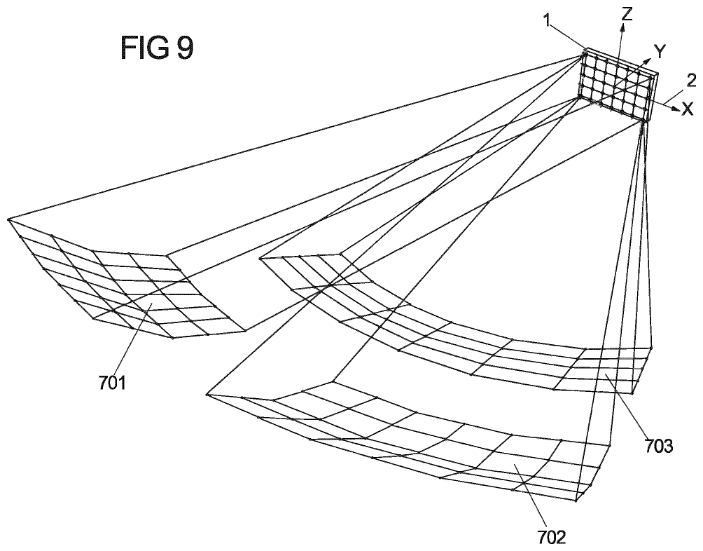

FIG. 9 describes an embodiment in which the audience area is divided into individual partial areas with different signal contents;

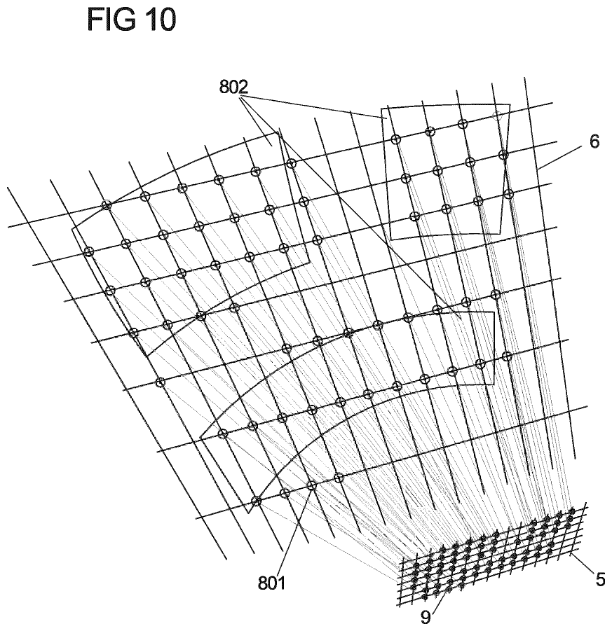

FIG. 10 describes an adapted sound transducer population for a non-variable audience area;

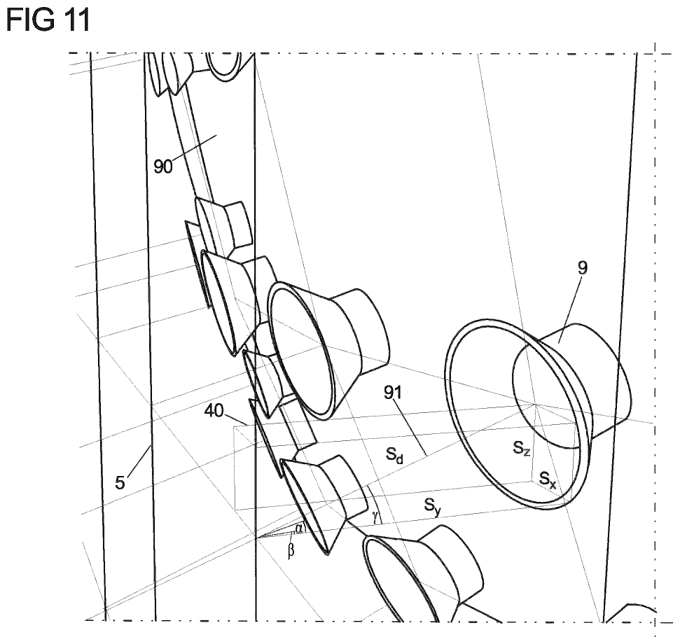

FIG. 11 describes an embodiment with a mechanically curved sound transducer surface;

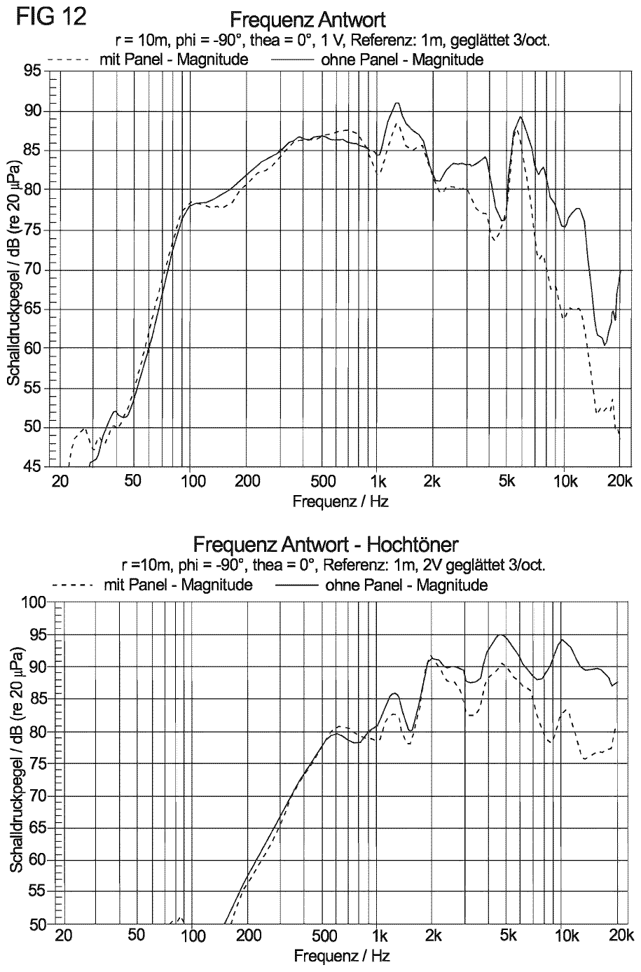

FIG. 12 describes frequency responses of a woofer (left) and a tweeter (right) with and without a semi-transparant plate, without signal processing;

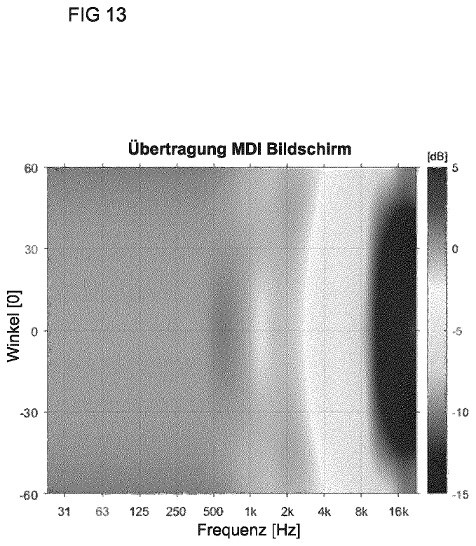

FIG. 13 describes a spatial transfer function of MDI Strong Panel; and

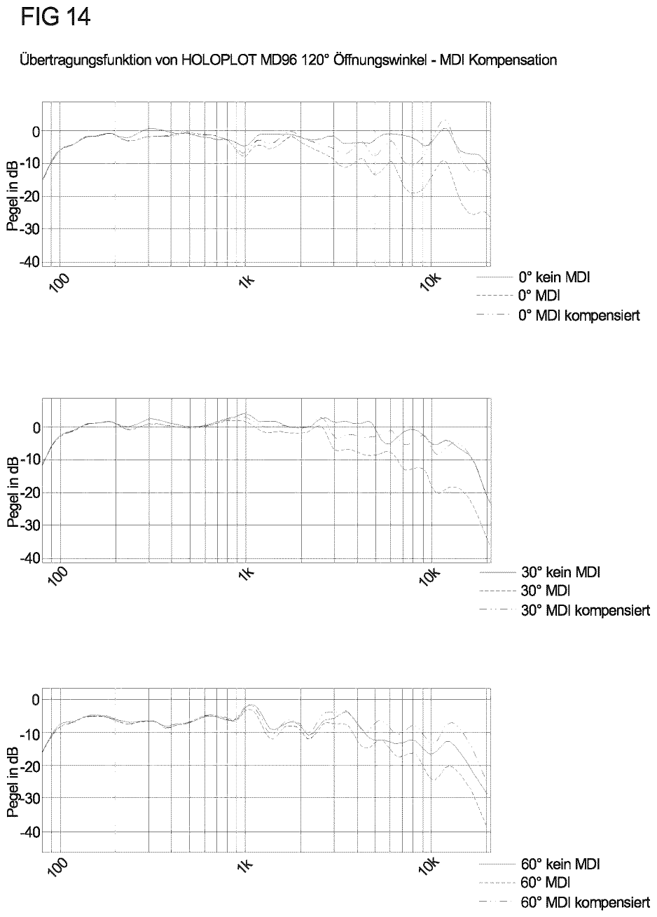

FIG. 14 describes a transfer function of the optimized 120° beam at the angles of 0°, 30° and 60°.

In FIG. 1, an embodiment of the method from [1] is briefly represented by way of example for explanation. The method is based on the fact that each sound transducer 9 in the sound transducer assembly 1 is associated with a point in the audience area 3. The procedure is executed separately for each sound transducer 9, each intersection point of a grid in the audience area 3 and each of the input signals of the system which are reproduced simultaneously. The mathematical method described in [1] thus supplies the delay time τ and the relative amplification factors \hat{d}ₙ for the respective sound transducer for each of the input signals.

The superposition of the elementary wave with the elementary waves of the adjacent sound transducers results in the respective desired local direction within the wavefront. The local propagation directions are composed to form a wavefront, the shape of which can be irregular depending on the shape and structure of the listener area. This is the only way to achieve level stability over a wide, irregularly shaped spectator area.

The individual input channels Ch 1 . . . Ch n are processed in the same way with their relevant data, and the sum of all signals gives the contribution of the respective sound transducer to the wavefronts which are simultaneously radiated with independent signal content in different directions and to different spectator areas.

In the method according to [1], the vector d for the local propagation direction of each wavefront is also available, with which the distance is determined for each individual sound transducer. Thus, the system is aware of the path that the corresponding wavefront must travel from the sound transducer to the listener. The polar coordinates φ and θ (i.e. spatial/3D polar coordinates or spherical coordinates), with which the local radiation direction of each individual wavefront is determined, are also available from the calculations.

The proposed solution describes how the spectral equilibrium of the spatial radiation of the sound transducer assembly 1 can be significantly improved.

In principle, the proposed solution can be used whenever the local radiation direction resulting from the superposition of the elementary waves of the surrounding speakers is known for each of the radiated wavefronts. This radiation direction is known in the method according to [1] from the direction of the vector d. However, it may also be derived from the geometric position of the corresponding sound transducer in relation to the virtual sound source in which the corresponding wavefront originates or be determined by other methods.

In addition to an even level distribution, the objective of each audio reproduction is to maintain the audio spectrum over the entire spectator area. In practice, however, there are some factors which largely prevent this objective from being achieved. First of all, the spatial radiation characteristics of the sound transducers used should be mentioned. From their diameter and other factors, direction-dependent and frequency-dependent level changes result, which lead to location-dependent spectral errors in the reproduction area. In addition, grids or other structures upstream of the radiation, for example a sound-permeable LED wall, as is described in [2], can change the reproduction spectrally greatly depending on the radiation direction. In very large audience areas, the airborne sound insulation, depending on relative humidity, air pressure and temperature, severely restricts the reproduction, especially in the upper audio frequency range, with increasing distance from the sound transducer assembly. Also, a targeted, direction-dependent frequency response change, for example to specifically design certain preferences of individual audience groups or the correction of hearing losses of individual persons or to expand the artistic possibilities for sound field design, has not been possible to date.

An embodiment of the proposed solution in the form of a method for correcting the direction-dependent frequency response of sound wavefronts which are generated by a two-dimensional sound transducer assembly according to the principle of wave field synthesis or according to beam forming is described in FIG. 2. The representation is limited to an exemplary signal processing for an individual sound transducer. A method represented in FIG. 2 can be applied to the method described in [1], for example, by additions in the software, provided that the resources of the hardware are sufficient for this purpose.

The signal lines of channels 1 . . . n carry the input signals of the system to all sound transducer units and to all modules. They can also be associated with individual groups of sound transducers which are provided for the radiation of different frequency ranges. Then the corresponding frequency response drop in the crossover range is already implemented, the sum signal of all frequency ranges is already equalized to a linear frequency response of the overall system in its main radiation direction.

After the delay with τ and the level regulation with the relative amplification factor dn for each individual sound transducer, each input channel is supplied to a summation before the signal controls the speaker. The extension of the system for correcting the direction-dependent frequency response is added before the signal delay in each input channel for the corresponding sound transducer. It is not important in which order the subsequent corrections are carried out. Also, individual corrections can be omitted or additional ones added.

In the exemplary representation, the correction of the direction-dependent frequency response changes of the individual sound transducers is arranged at the first position in the signal path. As with the other frequency response corrections, they are to be compensated by a forward correction. For this purpose, the 3D polar coordinates of the respective sound transducers installed in the module are individually determined and stored in the low-reflection space. In principle, it would also be possible to use the data of the half-space radiation provided by the manufacturer or the data of the measurements in an infinite sound wall. However, unevenness in the sound wall surface of the modules, in particular when multipath assemblies are used, result in significant differences from the radiation on a planar sound wall.

The measurement data are stored in angular steps in a spherical coordinate system having the radius 1, so that the relevant frequency response can be read out from the memory obtained from the sound transducer with the help of the polar coordinates φ and θ, with which the local radiation direction of each individual wavefront is determined. Thus, the data known from [1] for the local direction of the wavefront from the relation G(f,φ,θ) supply a frequency response curve which in a subsequent inverse filter Gᵢₙᵥ (j) is able to compensate as far as possible for the frequency response error of the corresponding sound transducer in the local radiation direction of the corresponding wavefront.

At the second position in the signal path, a compensation of acoustic obstacles in the signal path is represented by way of example. This can be a speaker grating that has a low-pass function and forms standing waves to the sound wall, or a perforated projection surface that is used as a projection surface in front of the sound transducer modules. In practice, there are also far more complex requirements, such as more massive projection surfaces, which only have local openings for the sound exit, or very complex, coarsely structured obstacles, such as the LED structure described in [2] in front of the sound transducer modules.

Here, too, the compensation is based on a forward correction of the sound transducers. Only that for the measurement of the polar radiation of the sound transducers the difference from the measurement of the individual sound transducers without the acoustic obstacle for the measurement of the polar radiation with the preceding obstacle is stored. The further steps are analogous to the correction of the sound transducers, compensated standardized in a subsequent member in an inverse filter with the function Hᵢₙᵥ (j).

The third correction member in the signal course serves to compensate for the airborne sound insulation in the signal course. Their influence on the frequency response depends on relative humidity (in %), air pressure (in kPa) and temperature (in K) and increases with the distance of the sound transducer to the listener. In principle, a data set with stored values could also be created here, but each of the three factors mentioned changes the curve in a different way; for this purpose, a data set for individual distance steps would have to be created for each one of the values. It is therefore more appropriate to provide the values for relative humidity (in %), air pressure (in kPa) and temperature (in K) valid for the entire system and to calculate the resulting frequency course of the airborne sound insulation in 1 meter from the known mathematical relationships directly for the distance of 1 meter and to multiply the values by the distance of the sound transducer to the viewer, which is known by the length of the vector d from [1]. With the resulting values Aᵢₙᵥ (j) the inverse filter then compensates for the airborne sound insulation of the relevant wavefront in the direction of the audience area.

To be able to calculate the compensation filters for each one of the three filter blocks, the data must be pre-processed. First, the data is normalized to change the overall amplification in all directions by a fixed value so that a desired level is reached. Thereafter, the data are regularized, which includes a frequency limitation as well as a spatial and spectral smoothing of the data. The smoothing degree depends on the required quality of the compensation and the available filter resolution. Finally, the normalized and regularized frequency response data for the given angles φ and θ (or d in the third block) are inverted, resulting in the final inverse filter.

Since the compensation can lead to undesirably high filter amplifications at certain frequencies or in certain directions, the maximum amount of the compensation can be limited by the regulation factors w_{G}, w_{H} and w_{A}

For this purpose, a limit value, for example for a maximum compensation of up to +12 dB, can be entered in the overall system. In principle, it is also possible to adapt this limit value to the current level of the corresponding input signal, so that the maximum headroom available is always used for the compensation.

Narrow-band frequency response drops below one-third of a width, such as can be caused, for example, by direction-dependent zero positions of the sound transducers, are subjectively hardly disturbing. This is different with the drop in the entire high-frequency range, which becomes clearly audible at long distances, especially in dry ambient air. Here it is important to make maximum use of the available headroom. One possibility of increasing it for the farther away areas is already described in the patent specification [1]. As the distance from the sound transducer assembly increases, equally large audience areas are associated with a larger number of sound transducers. With the described extension of the method described in [1], a very balanced level course can be achieved over a wide, irregularly shaped spectator area without significant sound discolorations.

The method described permits further refinements. As an example, the direction-dependent frequency response change mentioned at the beginning can be inserted as an additional correction member to specifically design certain preferences of individual audience groups or the correction of hearing losses of individual persons, or to expand the artistic possibilities.

Or the system can operate autonomously as an individual module with a permanently programmed directional effect and a permanently programmed direction-dependent correction of the frequency response. Then, in the case of fixed installations, a given spectator area can be sonicated with very high quality with one or more correspondingly programmed modules.

The employment of such modules with a permanently programmed directional effect and correspondingly permanently stored values for the direction-dependent correction of the frequency response of its sound transducers is also conceivable in the home. For example, when employed with a single input channel as a stereo speaker, a spectral constancy of the reproduction can thus be achieved via a specifically set radiation angle, which would never be achievable with individual speakers for the individual frequency ranges.

Further refinements and/or modifications are possible.

FIGS. 3 to 11 describe aspects for operating a sound transducer assembly 1, which can also be operated, for example, using the proposed solution (method, computer program product, sound transducer assembly).

In FIG. 3, a given audience area 3 is represented, which is to be sonicated with a planar sound transducer assembly 1 according to the principle of wave field synthesis (WFS).

During operation, the sound transducers of the sound transducer assembly 1 generate elementary waves 8 which are superposed to form a common wavefront 4. The common wavefront 4 is designed as if it were emanating from a virtual sound source 12. Accordingly, the surface of the wavefront 4 formed from the elementary waves 8 of the sound transducers 9 corresponds to a spherical segment. The common wavefront 4 is divided into rectangles 105 for illustration, which represent the proportions of elementary waves 8 generated in each case in approximately the same number of sound transducers of the sound transducer assembly 1 on the common wavefront 4.

In the spherical segment 4, the respective partial area 105, which is associated with a given number of sound transducers of the sound transducer assembly 1, is approximately of the same size. Correspondingly, the sound pressure is uniformly distributed on the surface of the wavefront 4 at the same time.

However, the audience areas 106 associated with these partial sections have a very different large surface on which the same energy of the associated spherical shaft section is distributed in each case. The sound pressure levels in the different parts of the spectator area 3 are correspondingly different.

The virtual sound source 12 is located in FIG. 1 behind the sound transducer assembly 1. The position of the virtual sound source 12 determines both the curvature of the common wavefront 4 and the direction in which it propagates. If the virtual sound source 12 is arranged near the sound transducer assembly 1, the supply area is wide and the curvature of the common wavefront 4 is strong. The surface of the common wavefront 4 increases correspondingly rapidly with the distance, the sound pressure level therefore decreases rapidly.

The further away the virtual sound source 12 is arranged from the WFS sound transducer assembly 1, the narrower the radiation angle and the smaller the curvature of the spherical segment. At a very long distance, there is almost a parallel wavefront, the level of which hardly decreases with the distance. As a result, however, the supply area 10 is narrowed to such an extent that only a part of the spectator area 5 is supplied. The position of the virtual sound source 12 is therefore a compromise between a wide supply range and an acceptable sound pressure drop in the rear rows of the audience area 3 to be sonicated. As also becomes clear in FIG. 1, the same number of sound transducers of the sound transducer assembly 1 supplies a portion of the audience area 3 to be sonicated which becomes significantly larger with the distance, the sound pressure drops correspondingly sharply here. In addition, it becomes clear that surfaces outside the audience area 3 to be sonicated are also unintentionally hit by the common wavefront 4 in the entire supply area 10.

The possibility is known of supplying the given audience area by means of several virtual sound sources which have the same signal content. A method for this is described in WO 2015/022579 A3. A three-dimensional further development of the method is described in patent application DE 10 2019 208 631 A1. The combination of several wavefronts emanating from different virtual sound sources permits a very balanced level course over wide audience areas 3. Reflection surfaces can be deliberately omitted and the level can be adjusted separately for each individual wavefront. Even in a sound-harsh environment, a high direct sound level with correspondingly good speech intelligibility can be achieved in the entire audience area 3. The methods come close to the goal of completely and very uniformly sonicating a given audience area 3 with a two-dimensional sound transducer assembly 1 according to the principle of wave field synthesis.

However, because of the different positions of the virtual sound sources, a time offset between the individual beams results in these methods (e.g. a sound radiation in a specific spatial angle range). This leads to comb filter effects in the frequency response in the boundary area of the beams if the time differences between them are not compensated. Such a time compensation is possible because the individual virtual sound sources can be controlled independently of one another in time. In the boundary areas of the individual beams, however, the offset can only be completely compensated for one point; at other locations, perceptible comb filter effects in the upper reproduction frequency range are unavoidable if wavefronts with coherent signal content overlap in the transition areas.

The audience area 3 at the venue is in principle predetermined, its shape and size can hardly be adapted in practice to the acoustic requirements for high-quality sound. Rarely is the area to be supplied a planar rectangle. Often, the area is asymmetric and rises more in the rear areas to ensure a clear view of the stage. The position of the two-dimensional sound transducer assembly 1, which can operate according to the principle of wave field synthesis, is also predetermined in principle because the sound source is to be located in the stage area.

Embodiments for methods with a substantially two-dimensional sound transducer assembly 1, as is known from wave field systems, to generate a closed wavefront without transitions between individual beams, which is designed in its shape in the azimuth and elevation plane such that a uniform distribution of the sound pressure level over the given audience area 3 is ensured, are explained hereinafter with FIGS. 4 to 11. This can be achieved if the spatial angle Ω of the proportion of a given number of sound transducers on the wavefront to be generated is adapted for a given part of the audience area 3 such that it respectively supplies an equally large part of the audience area 3. This would not be possible with discrete virtual sound sources of wave field synthesis.

FIG. 4 shows a sound transducer assembly 1 with a plurality of sound transducers. The sound transducer assembly 1 is used to sonicate an audience area 3. During operation, the individual sound transducers 9 of the sound transducer assembly 1 radiate elementary waves 8 which overlap to form a common wavefront 4.

The sound transducers 9 of the sound transducer assembly 1 are operated with individual delay times τⱼ, i.e. the sound transducers 9 radiate elementary waves 8 at individual delay times. The common wavefront 4 is formed by the operation of the sound transducer assembly 1 with the individual delay times τⱼ. In particular, the common wavefront 4 can be shaped by operation with individual delay times τⱼ such that it is adapted to the geometry of the audience area 3.

The sound transducer assembly 1 and the audience area 3 are associated with a common coordinate system 2 in which the positions of the individual sound transducers of the sound transducer assembly 1 are determined by position vectorssᵢ. The exact delay times of the individual sound transducers can be determined by interpolation from the calculated delay times of the surrounding intersection points of the auxiliary grid if the sound transducers are not arranged exactly at the origin of a position vector sᵢ.

The sound transducer associated with these position vectors sᵢ is driven with the individual delay time τⱼ for the radiation of elementary waves 8. Basically, the individual delay times τⱼ of the sound transducer 9 differ from one another, but they can also be at least partially identical.

Determining the delay times τⱼ is by means of an association which associated each intersection point of the auxiliary grid 5 with an intersection point of an auxiliary grid 6 in the audience area 3. In particular, this association associates the sound transducer 9 with the position vector sᵢ with a point in the audience area 3 corresponding to a position vector rᵢ.

From the association, the direction vectors 7 result which, starting from the intersection points of the auxiliary grid 5, point in the direction of the associated intersection points of the auxiliary grid 6 in the audience area 3. The standardized direction vectors in the cuboid 60, starting from the position vectors sᵢ are determined in each case by the provision

$${\hat{d}}_{i} = \frac{{r}_{i} - {s}_{i}}{\vert {r}_{i} - {s}_{i} \vert} .$$

The delay times τⱼ of the sound transducer determined with the help of the associated position vectors sᵢ are then each chosen such that the local direction 50 of the common wavefront 4 at the position vector rᵢ respectively corresponds to the direction of the standardized direction vector 61 \hat{d}ᵢ.

According to the proposed solution, the standardized direction vectors 61 thus determine the shape of the common wavefront 4. In particular, local directions 50 of the common wavefront 4 can be determined by the direction vectors 7. The standardized direction vectors 61 are in each case perpendicular to the common wavefront 4.

By a suitable choice of the association (see FIG. 8)—and thus of the standardized direction vectors 61—the common wavefront 4 can be shaped such that it adapts to the geometry of the audience area 3. This is done by the association of the grid points.

The wavefront 4 is then shaped such that the same number of sound transducers of the sound transducer assembly 1 is associated with equal partial areas 106 of the audience area 3. The corresponding partial surfaces 105 of the wavefront 4 then have a different size at the same time. At this distance, the upper partial area of the sketch is still significantly smaller than the lower one. Correspondingly, in this area the sound pressure within the same wavefront is significantly higher than in the lower partial area intended for the nearby spectator places.

FIG. 5 shows a reference surface 30 S which models the sound transducer assembly 1 in a coordinate system 2. On the reference surface 30 S of the sound transducer assembly 1, a regular, curved auxiliary grid 5 is arranged on which the positions of the individual sound transducers 9 of the sound transducer assembly 1 are aligned. By means of the reference surface 30S, in particular by means of the auxiliary grid 5, coordinates for the individual sound transducers 9 of the sound transducer assembly 1 in 3D space can be determined.

The reference surface 30 S is parameterized by a system of curved coordinates by means of the equation s(u, v)=[x(u, v) y(u, v) z(u, v)], wherein u and v are real variables.

A normal 202 n on the reference surface 101 S at s(u, v) is, by definition, a normal to the tangential plane spanned by the tangential vectors 201 sᵤ and sᵥ, given by the partial derivatives of s(u, v), wherein

$${s}_{u} = \frac{\partial s}{\partial u} = [ \frac{\partial x}{\partial u} \frac{\partial y}{\partial u} \frac{\partial z}{\partial u} ] \qquad ( 1 a )$$

$${s}_{v} = \frac{\partial s}{\partial v} = [ \frac{\partial x}{\partial v} \frac{\partial y}{\partial v} \frac{\partial z}{\partial v} ] \qquad ( 1 b )$$

The normal 31 n on s(u, v) is given by the cross-product of sᵤ and sᵥ as

$$n = {s}_{u} \times {s}_{v} . \qquad ( 2 )$$

The sound transducers 9 of the sound transducer assembly 1 themselves do not have to be mounted at the intersection points of the auxiliary grid 5, their respective delay and their level are interpolated to the intersection points in three-dimensional space. The curvature of the reference surface 30 S, as well as of the auxiliary grid 5, can be different in the azimuth plane than in the elevation plane, it is also possible to curve the auxiliary grid 5 only in one plane.

In practice, the reference surface 30 S of the sound transducer assembly 1, will usually be a planar surface and thus the auxiliary grid 5 will be a planar auxiliary grid. This corresponds to the case in which the sound transducers 9 are mounted substantially in a two-dimensional assembly. A planar surface is considered a special case of a curved surface.

FIG. 6 shows the association of the auxiliary grid 5 of a sound transducer assembly 1 with an auxiliary grid 6 in the audience area 3. The solution approach represented here does not start from the position of a virtual sound source (as represented in FIG. 3), but from the given geometry of the audience area 3 to be sonicated and the geometry of the sound transducer assembly 1.

In principle, the audience area 3 to be sonicated can be of any desired shape, planar, curved or also rising. FIG. 6 represents an irregularly shaped audience area 3 to be sonicated, which in particular is not symmetrical and rises more strongly in the rear area on the right than on the left side.

With conventional approaches, but also with virtual sound sources of the wave field synthesis, the task of supplying an audience area such as that represented in FIG. 6 with direct sound very uniformly is only insufficiently solvable because the curvature of the wavefronts of virtual sound sources of the wave field synthesis is always a spherical segment.

With the help of the represented association of the auxiliary grids 5 and 6, on the other hand, a common wavefront 4 can be generated which is adapted in its shape to the geometry of the audience area 3 to be sonicated.

To solve the problem, a coordinate system 2 is determined.

Coordinate points distributed over the audience area 3 to be sonicated are associated with the coordinate system 2. In FIG. 6, these coordinate points in the audience area 3 are arranged at the intersection points of an auxiliary grid 6, but they can also be distributed in the audience area 3 by other mapping methods.

In addition, an auxiliary grid 5 is associated with the coordinate system 2, by means of which the positions of the sound transducers 9 of the sound transducer assembly 1 can be determined. The auxiliary grid is represented in FIG. 5 as a planar, regular auxiliary grid. In principle, however, the auxiliary grid can also be curved, i.e. have curved lines. In principle, the auxiliary grid 5 can be arranged on a reference surface through which the sound transducer assembly 1 is modeled.

The number of the coordinate points in the audience area 3 corresponds to the number of the intersection points of the auxiliary grid 6. Thus, a coordinate point of the auxiliary grid 6 in the audience area 3 can be associated with each intersection point of the auxiliary grid 5. The distribution of the coordinate points is to take place over the entire audience area 3 with as uniform as possible spacings between the individual coordinate points.

A coordinate point with the position r(x, y, z) is associated with each intersection point of the grid 5 in the audience area 3. The connecting line 7 between the intersection points of the auxiliary grid 5 and its associated coordinate point in the audience area 3 then forms a vector in the coordinate system 2, which is the basis for the calculation of the running time and level of the audio signal.

The represented planar auxiliary grid 5 of the sound transducer assembly 1 has the shape of a rectangle whose aspect ratio is similar to that of the planned sound transducer assembly 1, for example in the form of a sound transducer array. It should have at least as many intersection points as sound transducers 9 are provided in the sound transducer assembly 1. In principle, the aspect ratio is not defined, so that it would also be possible to construct a single line of sound transducers if this is appropriate for the given spatial situation in the audience area 3.

The distance of the grid lines of the auxiliary grid 5 can be different in the horizontal and vertical planes, but should at least correspond to the number of rows and columns of the two-dimensional sound transducer assembly 1.

The sound transducers 9 of the sound transducer assembly 1 can be mounted with their acoustic center at the intersection points of the auxiliary grid 5. However, their position can also deviate from these intersection points, wherein their respective running times and levels are determined by interpolation of the values calculated for the surrounding grid points.

A higher number of grid lines improves the accuracy of the interpolation. A smaller number of grid lines results in a wavefront which is not uniformly curved but is composed of planar partial surfaces. The resulting diffraction effects lead to local irregularities in the frequency response.

In principle, it is not necessary for all intersection points of the auxiliary grid 5 to be associated with physical sound transducers 9. This makes it possible to interrupt the mounting in the areas in which the low midrange sound transducer 9 has its sound exit opening. In addition, all sound transducers 9 can be distributed slightly irregularly over the surface, as was described in DE 10 2009 006 762 A1. In this way, undesired aliasing effects in the audience area 3 can be reduced, because the comb filter effects resulting therefrom are statistically somewhat compensated for in the frequency response.

The auxiliary grid 6 placed over the audience area 3 completely encloses it. The auxiliary grid 6 is adapted in its shape to the audience area 3. In principle, this can be done manually. In practice, however, several hundred to several thousand grid points are necessary so that the distance between the sound transducers 9 is sufficiently small to achieve a reproduction which is largely free of audible aliasing effects. The small number of grid lines in the sketches serves to explain the functional principle of clarity.

It is therefore advantageous to automatically determine the coordinate points in the audience area 3 by means of a 3D CAD file of the audience area 3 using a suitable mapping method. Areas which are not intended to be directly hit by the common wavefront 4 because undesired reflections emanate from them can also remain free of associated grid points. Thus, they are not associated with sound transducers 9, the wavefront of which is sent directly in their direction. From these areas, the coordinate points are displaced without changing their number. Surrounding coordinate points shift accordingly to maintain an even distribution across the audience area 3. Each intersection point of the auxiliary grid 5 in the plane of the two-dimensional sound transducer assembly 1 is to be associated with a reference point in the audience area 3 to be sonicated.

Visualization in a 3D CAD file makes it easier to switch off unoccupied audience areas 3. In this case, the calculations remain unchanged in principle, only the sound transducers which are associated with unoccupied audience areas 3 are not supplied with signal. This results in a lower diffuse field sound level at the venue, which contributes to better speech intelligibility in the occupied audience areas 3.

FIG. 7 illustrates by way of example how the local curvature 50 of the wavefront 4, which according to the described method does not have to be a spherical segment, arises from the superposition of the elementary waves 8 of the surrounding sound transducers 9. The acoustic centers of the sound transducers 9 are mounted in the example on the intersection points of the auxiliary grid for the sake of simplification.

The individual sound transducer 9, represented in black in the sketch, has an undirected half-space radiation in accordance with the principle of wave field synthesis. Accordingly, the elementary wave 8 generated by it alone cannot form a direction vector. The local direction vector d of the wavefront associated with it is generated only at some distance from the sound transducer assembly 1 by superposition of the elementary waves 8 of the surrounding sound transducers.

The direction vector 7 d can be determined for this intersection by means of the provision

$$d = r - s \qquad ( 3 )$$

It is always orthogonal on the local wavefront 50.

In the exemplary representation in FIG. 7, the point described by the vector r lies at an intersection point of the auxiliary grid 6 of the audience area 3.

In principle, the direction vector 7 d can also be determined without the help of the auxiliary grid 5 and 6. In this case, the direction vector 7 d starts from a position vector s on a reference surface 30 S which models the sound transducer assembly 1 and points to a position vector r in the audience area 3 or to a position vector r which describes a point on a reference surface 30 modeling the audience area 3R.

In the following, a method is described for deriving delay times and levels for the individual sound transducers 9 from given direction vectors 7 so that the superposition of their elementary waves 8 is superposed on a wavefront which is consistently aligned with the given audience area 3.

In FIG. 8, the direction vector 7d selected by way of example from FIG. 6 is returned to the length of the standardized direction vector 61 \hat{d} which is defined as

$$\hat{d} = \frac{d}{‖ d ‖} \qquad ( 4 )$$

The desired wavefront, which is generated by the sound transducer assembly 1, in particular in the form of a curved or planar array, can be locally approximated by a planar wave which extends along (i.e. locally in the direction of) the standardized direction vector 61\hat{d}. Each local planar wave can be directed in the desired direction by operating the sound transducers 9 of the sound transducer assembly 1 in accordance with the corresponding delay times of the signal.

The delay time τⱼ at each position s(u, v) on the reference surface 30 S of the sound transducer assembly 1 is determined by the scalar delay function τ(u, v).

In vector computation, the gradient of a scalar function ii of several variables is a vector field ∇τ, the components of which can be determined by partial derivatives from τ, in particular, the following applies:

$$∇ τ ( u , v ) = [ \frac{\partial τ}{\partial u} \frac{\partial τ}{\partial v} ] \qquad ( 5 )$$

The delay gradient ∇τ(u, v) can be determined in the following manner:

The scalar products of the standardized direction vector 61 \hat{d} and tangent vectors sᵤ, and sᵥ, or \hat{d}ᵤ and \hat{d}ᵥ are given by

$${\hat{d}}_{u} = \hat{d} \cdot {s}_{u} \qquad ( 6 a )$$

$${\hat{d}}_{v} = \hat{d} \cdot {s}_{v} \qquad ( 6 b )$$

The scalars \hat{d}ᵤ and \hat{d}ᵥ can be interpreted physically as the local differentials of the path lengths between the plane wave and the tangential plane of the sound transducer assembly 1.

In the special case of a planar sound transducer assembly 1, as is represented in FIG. 8, \hat{d}ᵤ and \hat{d}ᵥ are equal to the quantities illustrated in FIG. 8 \hat{d}ₓ and \hat{d}_{z}, which represent the x and z components of the vector \hat{d}.

The relationship between the delay gradient ∇τ(u, v) from equation (5) and the components \hat{d}ᵤ, and \hat{d}ᵥ is given by the sound speed c. Therefore, the partial derivatives of the delay function τ can be described as

$$\frac{\partial τ}{\partial u} = \frac{{\hat{d}}_{u}}{c} \qquad ( 7 a )$$

$$and$$

$$\frac{\partial τ}{\partial v} = \frac{{\hat{d}}_{v}}{c} . \qquad ( 7 b )$$

In practice, the distance between the sound transducers 9 is finite. Therefore, the differential equations from equations (7a) and (7b) must be rewritten into discrete difference equations. The delay differences Δᵤτ and Δᵥτ in the it or v direction are now given by

$${Δ}_{u} τ = \frac{{\hat{d}}_{u}}{c} Δ u \qquad ( 8 a )$$

$$and$$

$${Δ}_{v} τ = \frac{{\hat{d}}_{v}}{c} Δ v , \qquad ( 8 b )$$

wherein Δu and Δv are the discrete steps in the u or in the v direction. The required delay can be found by numerical integration of the discrete 2D vector field[ΔᵤτΔᵥτ].

Several mathematical integration methods are available, such as the composite trapezium, Simpson, or more advanced inverse gradient method. The integration constant can be chosen freely. To meet the causality condition and minimize system latency, the minimum delay across all drivers is subtracted from the calculated delays.

The relative amplification factor \hat{d}ₙ for each position in the sound transducer assembly 1 is given by the scalar product of the standardized direction vector 61 \hat{d} and the normal n according to the equation

$${\hat{d}}_{n} = \hat{d} \cdot n , \qquad ( 9 )$$

wherein the normal n is as defined in equation (2).

By operating the sound transducers 9 according to the relative amplification factors \hat{d}ₙ, it is ensured that the sound pressure level at the receiver position r is independent of the angle of the direction vector d to the normal n.

With increasing inclination of the radiation compared to the normal n, the number of the sound transducers 9 becomes larger in a given spatial angle Ω so that the sound pressure level would increase here.

The compensation according to equation (9) corrects this in accordance with a cosine function of the angle γ in FIG. 6. With an even distribution of the coordinate points r, this ensures a very homogeneous distribution of the sound pressure over the entire audience area 3 to be sonicated.

FIG. 9 represents that the audience area 3 to be sonicated can also be divided into individual partial areas 701,702,703 with different signal contents.

In principle, these partial areas could then also be distributed to partial areas of the sound transducer assembly 1. However, a clearly precise sonication results if the high directivity of the entire assembly is used to align the signal contents to the desired audience areas 3. In each of the partial areas 701, 702, 703, the number of the intersection points 6 then corresponds to the number of the intersection points 5 of the auxiliary grid of the sound transducer assembly 1.

With the same signal content, the division into partial areas does not make sense if the partial areas are not sufficiently spatially separated. If the signal content were coherent, comb filter effects would then arise at the area boundaries.

Individual partial areas can also be smaller than the associated sound transducer 9 surface, insofar as the intersection points of the auxiliary grid are closer to one another in the audience area 3 than in the auxiliary grid of the sound transducer assembly 1. In this case, concave wavefronts are created, the sound pressure level of which is higher in the audience area 3 than at the generating radiator surface itself.

It is also possible to reduce the size of an auxiliary grid in the audience area 3 to a point. The two-dimensional sound transducer assembly 1 then generates the same concave wavefront in accordance with the vector-based method described, as it arises in a two-dimensional sound transducer assembly 1 in accordance with the principle of the wave field synthesis in a virtual sound source at this point.

With the coordinates of the grid points 5 on the reference surface of the sound transducer assembly 1 and their associated coordinates 6 in the audience area 3, it is also possible to compensate for the sound pressure drop at higher frequencies through the airborne sound insulation. At a given humidity, the frequency-dependent attenuation values of the air per meter are exactly known. A corresponding inverse equalization curve can then be associated with each sound transducer 9 because the distance to the relevant spectator place (given by the length of the direction vector d in FIG. 7) is known.

In large audience areas 3, the sound pressure drop at the upper limit of the audio range can rise well above ten dB in dry air. In any case, this frequency range must be controlled significantly higher in a flat sound transducer assembly 1 because the level gain due to the improved adaptation of the synchronously working speaker group only takes effect at relatively long wavelengths. The additional compensation of the airborne sound insulation for the far-away audience areas 3 can therefore bring the system to the limit of controllability at high signal levels in the upper audio frequency range.

A solution to this problem is to arrange the coordinate points r at a distance from the sound transducer assembly 1 closer to one another. In the far-away audience areas 3, the same number of sound transducers 9 is then associated with a smaller partial area 106. Each halving of the surface causes a level increase by 3 dB by which the control of the associated sound transducers 9 would have to be reduced so that the sound pressure level remains almost the same in the entire audience area 3. The correspondingly reduced control signal is connected to a larger headroom in the associated amplifiers. This can then be used to equalize the drive signals to a greater extent.

In the method described, the localization of the sound source differs fundamentally from the localization of a virtual point sound source of the wave field synthesis. In wave field synthesis, virtual sound sources are in principle localized at their virtual starting point independently of the position of the listener in the supply area, comparable to a real sound source.

However, the wavefront tailored to the audience area 3 does not start from defined positions of virtual sound sources. It is created, as it were, from an extended source of many different starting points in the area behind the sound transducer surface. The viewer in the front left place in FIG. 4 will associate the starting point with the wavefront in the lower left corner of the sound transducer assembly 1, for the viewer at the right rear the sound comes from the tipper right corner of the sound transducer assembly 1. This is not a disadvantage for reproduction without an optical reference to the sound source, but spatial reproduction is possible only to a limited extent in accordance with FIG. 4.

Nevertheless, the method can be associated with the field of wave field synthesis because it is possible to generate any desired form of the wavefront from the theoretical derivation of the wave field synthesis from the Kirchhoff-Helmholtz integral (Jens Ahrens: The Single-layer Potential Approach Applied to Sound Field Synthesis Including Cases of Non-enclosing Distributions of Secondary Sources, Dissertation, Technische Universitat Berlin, 2010).

### Further Refinements

Until now, it has been assumed that the sound transducers 9 of the sound transducer assembly 1 are arranged in a regular grid. In practice, however, the distribution of the sound transducers 9 can also be irregular. First, the running times r are calculated on a sufficiently dense regular grid, after which the running times are interpolated to the irregularly placed sound transducers.

FIG. 10 shows a complexly designed audience area 3 with partial areas 802 and illustrates an equipping of the sound transducer assembly 1 with sound transducers 9, wherein the equipping is adapted to the complex design of the audience area 3.

In the represented embodiment, the association between points on the sound transducer assembly 1 and points in the audience area 3 is by means of an association of intersection points of the auxiliary grids 5 of the sound transducer assembly 1 with intersection points of the auxiliary grid 6 of the audience area 3.

However, not all intersection points of the auxiliary grid 5 are associated with sound transducers 9 of the sound transducer assembly 1, in other words, intersection points of the auxiliary grid 5 remain unequipped. In particular, there are unequipped intersection points between equipped intersection points.

The shape of the sound transducer assembly 1 can thus be adapted to the complex design and/or the geometry of the audience area 3 in fixed installations. This allows a more effective employment of the sound transducers.

The auxiliary grid 6 in the audience area 3 can be, for example, a rectangle, and it can in particular extend beyond the audience area.

Irregular shapes of the auxiliary grid 6 can lead to incorrect results in the calculations according to the described method.

Intersection points of the auxiliary grid 6 in the audience area 3 which have no associated audience, i.e. which in the present case lies outside the partial areas 5a, 5b, 5c of the audience area 3 to be sonicated, are associated with auxiliary grid points of the auxiliary grid 5 of the sound transducer surface which are not equipped with sound transducers or are switched off.

The auxiliary grid 5 of the sound transducer assembly 1 is optionally also aligned with employed low midrange sound transducers. The calculation of their running times and levels depends on the grid points nearby. The time shift for a possible depth offset is to be compensated. The phase position of subwoofers can also be adapted effectively in this way. According to the method, the shortest of all the calculated running times to the individual sound transducers is subtracted from all the calculated running times, so that the front of the wavefront adapted to the audience area 3 is always generated directly.

A further refinement relates to a device which is shaped in accordance with the rules of the described method. With it, a single wavefront, which is adapted in its shape to the given listener area, can be generated from a mono signal without an electronic time shift of the signal. This mechanical solution can be advantageous for fixed installations in an acoustically problematic environment. For example, it is possible to install a sound system at reasonable effort which ensures a high proportion of direct sound with correspondingly good speech intelligibility even under unfavorable acoustic conditions.

A mechanically curved sound transducer assembly 1 is illustrated by way of example in FIG. 11.

By means of the mechanically curved sound transducer assembly 90, the audience area 3 to be sonicated, which is described with reference to FIG. 6, can be supplied with a cut-to-size common wavefront 4.

In this case, the operation of the sound transducers 9 of the sound transducer assembly 1 is realized mechanically in accordance with the delay times τⱼ obtained by the described method. All sound transducers are supplied with a coherent signal, i.e. from a mono signal source.

The mechanical realization is achieved by suitable positioning of the sound transducers 9 on the mechanically curved sound transducer assembly 90, in particular by a suitable spatial offset, in particular an offset in the propagation direction of the common wavefront, of the sound transducers 9 relative to one another.

To determine the respective position of the sound transducers 9 in the adapted sound transducer surface for the audience area 3 to be sonicated, a distance S_{d}, starting from the associated grid point of a plane auxiliary grid 5, along the extended diagonal of the cuboid 40 intended for the unit vector 61 \hat{d}, is removed.

With the help of the alternating angles α and β thus known, the new coordinates for the acoustic center of the relevant sound transducer 9 and also its orientation can be determined in the right-angled triangles of the cuboid 40.

The delay times calculated according to the methods described for the individual sound transducers 9 are created by the mechanical offset of the acoustic centers of the respective sound transducers 9 along the diagonal S_{d} of the respective cuboids.

The different signal levels for the individual sound transducers 9 of this two-dimensional sound transducer assembly 1 can then be realized approximately at a common final amplifier by suitable parallel and series connection of the sound transducers 9 or by connection to different amplifiers, which are respectively associated with sound transducers 9 with approximately identical level values.

Insofar as the sound transducers 9 have no significant drops in their spatial radiation characteristic, they do not have to be oriented in the direction of the diagonal of the cuboid. The method can then also be realized by a device for the transverse displacement of sound transducers, as is described in WO 2015/004526/A2. The displacement s_{y} of the acoustic center of the original sound transducer grid from the grid point then results from the quotient

$$\frac{{S}_{d}}{cos γ} .$$

A single mechanical device cannot generate spatial sonication of the audience area 3. It is suitable for ensuring, with a manageable effort, a sonication in which the distribution of the sound pressure level is very uniform throughout the audience area 3 and which ensures a high level of speech intelligibility even in acoustically unfavorable spaces.

In the following, some embodiments for methods and devices for the sonication of a given audience area 3 by means of a sound transducer assembly 1, which are controlled with individual delay times and levels in accordance with the principle of wave field synthesis, are represented.

Thus, for example, in a variant 1 in a method, the shape of the acoustic common wavefront 4, which is composed by superposition of elementary waves 8 of the sound transducers 9, can be determined from the given geometry of the audience area 3 and the sound transducer assembly 1 in such a way that, in a common coordinate system 2, a coordinate point in the audience area 3 is associated with each intersection point of a regular, at least partially planar and/or curved grid which is associated with the sound transducers, wherein a vector results from their connecting line, from which the delay time for the respectively associated sound transducer 9 can be calculated by mathematical linking, as a result of which the local curvature of the wavefront, which is created by superposition of the elementary waves 8 of the surrounding sound transducers 9, progresses in the direction of this vector, so that a closed wavefront is created which can reach the entire audience area 3 and in which also a level correction becomes possible for each sound transducer 9 from its associated vector, which improves the homogeneity of the sound pressure over the entire audience area 3.

In a refinement of variant 1, for example, the coordinate points in the plane of the two-dimensional sound transducer assembly 1 are intersection points of a plane or curved grid with which coordinate points in the audience area 3 are associated in a common coordinate system 2, wherein the connecting lines between the respectively associated grid points and points in the audience area 3 do not cross or intersect.

In a further refinement, the number of the grid lines in the plane of the two-dimensional sound transducer assembly 1 in the horizontal and vertical direction corresponds in each case to the number of the sound transducers installed in the rows and columns of the two-dimensional sound transducer assembly 1. Alternatively, the number of the grid lines can be greater than the number of the sound transducers 9 in the rows and columns of the two-dimensional sound transducer assembly 1, wherein it is possible for the acoustic center of the individual sound transducers 9 to be arranged at the intersection point of the grid lines. The values for delay time and/or level can be determined, for example, by interpolating the values of the surrounding grid points in that the reference points in the audience area 3 can be adapted in all three spatial dimensions to the requirements of the geometry of the audience area 3, wherein care has to be taken that the areas between the individual grid points remain approximately the same size over the entire audience area 3, as a result of which a relatively uniform distribution of the sound pressure level over the entire audience area 3 results.

In a further refinement of variant 1 or one of the above variants, the vectors which result from the difference of the coordinates of the grid point associated with the respective sound transducer 9 in the plane of the two-dimensional sound transducer assembly 1 to the respective position of the associated coordinate point in the audience area 3 are applied to components of the unit vector \hat{d} to create a mathematical basis for determining the time differences between adjacent sound transducers.

In principle, physical sound transducers 9 which radiate the same frequency range do not have to be associated with all intersection points of the auxiliary grid. This makes it possible, for example, to interrupt the equipping in the areas in which low midrange sound transducers 9 have their sound exit opening or to place high-frequency speakers in front of the low midrange sound transducers, wherein the running time differences are compensated for by the mechanical offset by interpolation at the intersection points of the auxiliary grid.

In a further refinement of the variants described above, the influence of the angle which the synthesized wavefront assumes at a given grid point relative to the plane of the sound transducer assembly 1 on the signal level perceived at the associated point in the audience area 3 is compensated in that the level of the sound transducer associated with the respective point is compensated with the cosine function of the relevant angle, wherein the value of this cosine function corresponds to the value of the component \hat{d}ₙ of the unit vector \hat{d}.

In principle, several auxiliary grids in the audience area, each having the same number of points as the grid in the plane of the two-dimensional sound transducer assembly 1, can also be associated with the intersection points of the planar or curved grid in the plane of the two-dimensional sound transducer assembly 1, as a result of which partial areas within the audience area can be supplied, for example simultaneously, with different signal contents.

The reference points in the audience area 3 can be distributed more narrowly with increasing distance from the two-dimensional sound transducer assembly 1, for example with the intention of making the areas between the reference points smaller with the distance from the two-dimensional sound transducer assembly 1, so that the associated sound transducers 9 of the two-dimensional sound transducer assembly 1 can be controlled at a lower level with unchanged sound pressure in the respective area, as a result of which more headroom is available for the compensation of the height drop due to the airborne sound insulation in these areas.

The influence of the airborne sound insulation on the signal at the spectator's place for the individual sound transducers 9 can be compensated in that their respective input signal is compensated for by the inverse equalization of the influence of the airborne sound insulation at a given atmospheric humidity in accordance with the distance ∥d∥ of the associated vector.

In principle, individual audience areas 3, for example temporarily, can be excluded from supply. For example, if they are not occupied at an event, which improves the proportion of direct sound in the rest of audience area 3.

In a device for the sonication of a given audience area 3, the running times with which the individual sound transducers 9 of the two-dimensional sound transducer assembly 1 radiate according to one of the above-described method variants are not realized by electronic delay of the signal content, but by the mechanical positioning of the sound transducers which are controlled with coherent signals, wherein the signal levels for the respective sound transducer 9 corresponds to the values determined for the original intersection points of the grid.

In the following, some embodiments of the method for direction-dependent correction of the frequency response of sound wavefronts are described.

Thus, for example, in variant 1a, the direction-dependent correction of the frequency response of sound wavefronts, which are generated by a two-dimensional sound transducer assembly according to the principle of wave field synthesis or according to beamforming methods, for example as an extension of the method described in German Patent Application No. 10 2021 207 302.6 [1] for the sonication of a given spectator area, in which several input signals can be associated simultaneously and independently of one another with different spectator areas, wherein the signal levels are adapted such that a very balanced sound pressure level is ensured in the entire spectator area, nonlinearities in the frequency response of individual wavefronts over the entire audience area can be largely compensated for by additional insertion of corresponding correction members into the signal path of each input channel for each respective sound transducer in that, depending on the local radiation direction of the wavefront to be corrected in each case in relation to the front surface of the two-dimensional sound transducer assembly, based on an inverse forward correction of the factors which physically influence a linearization of the radiation of each sound transducer is compensated for each of the input channels of the system.

In a refinement of variant 1a, nonlinearities of the frequency response which are dependent on the radiation direction are largely compensated for by forward correction for the individual sound transducers of the sound transducer assembly by the data of the respective sound transducers installed in the module which are stored under the 3D spherical coordinates being determined and stored individually in the low-reflection space, so that their frequency response in the radiation direction of the respective wavefront is called up from the memory by means of the spherical coordinates φ and θ and, as a function Ginv (f), the frequency response error of the respective sound transducer in the local radiation direction of the respective wavefront is largely compensated by an inverse filter additionally inserted into the respective signal path.

Additionally or alternatively, in one embodiment, the frequency response errors caused by acoustic obstacles in the propagation direction of the wavefront can be largely compensated by forward correction in that the differences between the 3D spherical coordinates of the individual sound transducers between an unimpeded radiation and the radiation behind the structure which impedes the propagation of the respective wavefront are spatially detected and stored as 3D spherical coordinates, so that the difference between the two frequency responses in the radiation direction of the respective wavefront are called up by means of the polar coordinates φ and θ and normalized and inverted as a function Hinv (f) compensate to the greatest extent the frequency response error caused by the acoustic obstacle in the local radiation direction of the respective wavefront by an inverse filter additionally inserted into the respective signal path.

Additionally or alternatively, the influence of the airborne sound insulation on the frequency response of the respective wavefront can be largely compensated for in that the attenuation course for the distance of 1 meter is calculated directly from the known mathematical relationships with the actual values for relative humidity (in %), atmospheric pressure (in kPa) and temperature (in K) in the audience area and the inverted and normalized values are multiplied by the distance of the sound transducer to the listener area, to which the local part of the relevant wavefront is directed, to compensate the distance-related level loss of the relevant wavefront in the direction of the audience area by means of filters in the signal path with the resulting function Ainv(f).

Additionally or alternatively, the inversion of the frequency response resulting from the stored or calculated data can be connected upstream of the filters in the signal path to compensate for a frequency response drop by a correspondingly higher amplification and to reduce a resonance increase by attenuating the signal in the corresponding frequency range, wherein the correction can be carried out in octaves, thirds or smaller frequency steps, and wherein a shift of the total level of the relevant channel upstream of the filter is compensated by a corresponding correction of the total level of the correction curve, in which a maximum value for the compensation then prevents an overcontrol of the subsequent stages in individual frequency ranges.

Additionally or alternatively, additional polar frequency response data and inverse or non-inverse filters, which effect a direction-dependent frequency response change for selected wavefronts, and with which certain preferences of individual audience groups or the correction of hearing losses of individual persons or extended artistic design possibilities for the spatial sound field or other acoustic targets can be inserted as an additional correction member in the signal path.

In principle, the sequence of the correction members in the signal path can be freely chosen and individual correction possibilities can be bridged or omitted.

Additionally or alternatively, fixed correction values can be stored in the system if the direction of the wavefronts is fixed in the system.

In principle, in systems with a permanently programmed directional effect and a permanently programmed directional-dependent correction of the frequency response, it is possible to operate autonomously as individual modules or to be joined together with further modules, which are correspondingly programmed, to form a permanently programmed sound transducer array.

Additionally or alternatively, the data for the directional characteristic can be stored in the individual modules and read from a central memory and overwritten via a data bus in a setup process.

Further embodiments are described hereinafter.
Example 1. Method for the acoustic sonication of at least one audience area (3) by at least one sound transducer assembly (1) having a plurality of sound transducers (9), wherein the individual sound transducers (9) of the at least one sound transducer assembly (1) in each case radiate elementary waves (8) which are superposed to form a common wavefront (4),
characterized in that
a) the at least one sound transducer assembly (1) and the at least one audience area (3) are geometrically linked to one another by a coordinate system (2), and
b) between the physical positions of the individual sound transducers (9) in the at least one sound transducer assembly (1) and position vectors sᵢ there is a spatial association for determining coordinates in the area of the at least one sound transducer assembly (1), and further
c) there is an association of points of the coordinate system (2) with points in the at least one audience area (5) corresponding to a position vector rᵢ, wherein
d) direction vectors, in particular standardized direction vectors (61), result in the coordinate system (2)

$${\hat{d}}_{i} = \frac{{r}_{i} - {s}_{i}}{\vert {r}_{i} - {s}_{i} \vert}$$

and
e) depending on the spatial association of the position vectors sᵢ and the sound transducer (9), delay times τⱼ are determined for the sound transducers (1) by means of which elementary waves (8) are radiated through the sound transducers (9), wherein
e) the delay times τⱼ of the sound transducers (9) are in each case chosen such that the local direction (50) of the common wavefront (4) corresponds to the direction of the direction vector, in particular of the standardized direction vector (61)\hat{d}ᵢ.
Example 2. Method according to example 1, characterized in that the sound transducers (9) of the at least one sound transducer assembly (1) are arranged in or on a plane or in or on an at least partially curved or planar surface (30), in particular in the manner of a grid, wherein the position of the acoustic centers of the sound transducers can deviate from the intersection points of the auxiliary grid (5), provided that the associated change in delay time and level is corrected by spatial interpolation or other methods.
Example 3. Method according to example 1, characterized in that the sound transducers (9) of the at least one sound transducer assembly (1) are arranged in a three-dimensional area, in particular in a space, in particular such that at least a partial amount of the sound transducers (9) of the at least one sound transducer assembly (1) is arranged on a reference surface (30), and the positions of the remaining sound transducers (9) of the at least one sound transducer assembly (1) can be determined by an offset (91) into the three-dimensional area.
Example 4. Method according to at least one of the preceding examples, characterized in that the operation of the sound transducers (9) with a delay time τⱼ is controlled by a control by means of a computer system and/or mechanically, in particular by spatially offsetting (91) the sound transducers (9) of the at least one sound transducer assembly (1) relative to one another.
Example 5. Method according to at least one of the preceding examples, characterized in that the at least one audience area (3) has at least partially a concave and/or at least partially a convex shape.
Example 6. Method according to at least one of the preceding examples, characterized in that the at least one audience area (3) can be described as a continuous surface.
Example 7. Method according to at least one of the preceding examples, characterized in that the at least one audience area (3) can be described as a discontinuous surface which is composed of at least two continuous surfaces.
Example 8. Method according to at least one of the preceding examples, characterized in that the position vectors sᵢ result in a regular grid.
Example 9. Method according to at least one of the preceding examples, characterized in that the position vectors rᵢ result in a regular grid (6) on a surface associated with the at least one audience area (3).
Example 10. Method according to at least one of the preceding examples, characterized in that the association which associates the point in at least one audience area (3) with each position vector sᵢ corresponding to the position vector rᵢ can be determined by means of connecting lines from the at least one sound transducer assembly (1) into the audience area (3).
Example 11. Method according to at least one of the preceding examples, characterized in that the levels at which the sound transducers (9) of the at least one sound transducer assembly (1) are operated are adapted such that the sound pressure in the at least one audience area (3) is homogeneous.
Example 12. Method according to Example 11, characterized in that the levels at which the sound transducers (9) of the at least one sound transducer assembly (1) are operated can be determined by means of a relative amplification factor based on the rule \hat{d}ₙ=\hat{d}ᵢ·nᵢ, wherein nᵢ in each case describes the normal to the reference surface (30) S on the position vector sᵢ which is associated with the sound transducer (9).
Example 13. Method according to at least one of the preceding examples, characterized in that the at least one audience area (3) has at least two partial areas which are sonicated with different signal contents.
Example 14. Method according to at least one of the preceding examples, characterized in that the common wavefront (4) is shaped such that it is adapted to the geometry of the at least one audience area (3), in that the grid points are associated and the common wavefront (4) is then shaped such that partial areas (106) of the at least one audience area (3) of equal size are associated with substantially the same number of sound transducers (9) of the sound transducer assembly (1).
Example 15. Method according to at least one of the preceding examples, characterized in that partial areas of the at least one audience area (3) are assigned partial areas of the sound transducer assembly (1), with which a different audio content can be associated simultaneously, wherein a directivity of the sound transducer device (1) is used to align signal contents to predetermined parts of the at least one audience area (3), wherein in each of the partial areas (701, 702, 703) the number of intersection points (6) then corresponds to the number of intersection points (5) of the auxiliary grid of the sound transducer assembly (1).
Example 16. Method for determining delay times τ₁ for operating sound transducers (9) of at least one sound transducer assembly (1) with a plurality of sound transducers (9) j for generating elementary waves (8) according to the delay times τⱼ for sonicating at least one audience area (3), comprising the following steps:
Determining a coordinate system (2) by which
the at least one sound transducer assembly (1) is approximately described as a two-dimensional reference surface (30) S of the at least one sound transducer assembly (1) and
the at least one audience area (3) is approximately described,
determining position vectors s on the reference surface (30) S of the at least one sound transducer assembly (1), from which the positions of the sound transducers (9) of the at least one sound transducer assembly (1) can be determined,
determining an association which associates each position vector s on the reference surface (30) S of the at least one sound transducer assembly (1) with a position vector r corresponding to a point in the at least one audience area (3),
determining direction vectors, in particular standardized direction vectors (61) \hat{d}starting from the position vectors s, wherein the standardized direction vectors (61) \hat{d} starting from the position vectors s respectively point in the direction of the position vector r associated with the position vector s; and
determining delay times τⱼ for sound transducers j so that the elementary waves (8) generated by the sound transducers (9) change during operation according to the delay times τⱼ to form a common wavefront (4), wherein the standardized direction vectors (61) \hat{d} respectively describe local propagation directions (50) of the common wavefront (4).
Example 17. Method according to example 16, comprising determining relative amplification factors \hat{d}ₙ for at least a partial amount of the position vectors s according to the provision

$${\hat{d}}_{n} = \hat{d} \cdot n ,$$

wherein n is a normal to the reference surface (30) S of the sound transducer assembly (1) at the point determined by the position vector s and \hat{d} is the standardized direction vector (61) starting from the position vector s.
Example 18. Method according to example 16 or 17, characterized in that the position vectors s describe the positions of the transducers (9).
Example 19. Method according to at least one of the examples 16 to 18, characterized in that each position vector s on the reference surface (30) S of the at least one sound transducer assembly (1) is associated with a position vector r on a reference surface R of the at least one audience area (3) and the determination of the direction vector, in particular of the standardized direction vector (61) \hat{d} for at least one position vector s is by means of a connecting line (7) between the position vector s and the position vector r, in particular in accordance with the calculation provision

$$\hat{d} = \frac{r - s}{\vert r - s \vert} .$$

Example 20. Method according to example 19, characterized in that the connecting lines (7) for determining the standardized direction vectors (61) \hat{d} respectively do not cross or intersect each other in pairs.
Example 21. Method according to at least one of the examples 16 to 20, characterized in that the association between the position vector s and the position vector r is automatically, in particular on the basis of a 3D CAD file of the at least one audience area (3).
Example 22. Method according to at least one of the examples 19 to 21, characterized in that the position vectors r are evenly distributed on the reference surface R of the at least one audience area (3) and thus correspond to evenly distributed points in the at least one audience area (3).
Example 23. Method according to at least one of the examples 16 to 22, characterized in that the reference surface R of the at least one audience area (3) is described by an auxiliary grid (6) on which the position vectors r are at least partially intersection points.
Example 24. Method according to at least one of the examples 16 to 23, characterized in that the reference surface (30) S of the at least one sound transducer assembly (1) is described by an auxiliary grid (5) on which the position vectors s are at least partially intersection points.
Example 25. Method according to at least one of the examples 16 to 24, characterized in that the reference surface (30) S of the at least one sound transducer assembly (1) is parameterized by means of the coordinatess(u, v)=[x(u, v) y(u, v) z(u, v)], wherein u and v are real, continuous variables or discrete variables and thus, in particular, the position vectors s can be described in the form s=s(u, v).
Example 26. Method according to examples 16 and 25, characterized in that the normal n to the reference surface (30) S of the sound transducer assembly (1) at the point described by s=s(u, v) is given by the cross-product of sᵤ and sᵥ as

$$n = {s}_{u} \times {s}_{v} ,$$

wherein
sᵤ and sᵥ are given by the partial derivatives

$${s}_{u} = \frac{\partial s}{\partial u} = [ \frac{\partial x}{\partial u} \frac{\partial y}{\partial u} \frac{\partial z}{\partial u} ] or$$

$${s}_{v} = \frac{\partial s}{\partial v} = [ \frac{\partial x}{\partial v} \frac{\partial y}{\partial v} \frac{\partial z}{\partial v} ] .$$

27. Method according to example 26, characterized in that for determining the respective delay times τⱼ, first, a scalar function of delay times τ(u, v) for a finite amount of position vectors of the form s=s(u, v) is determined and the determination of the delay times τⱼ for the sound transducers (9) with the position vector sᵢ is done at least partially by interpolation of at least two respective values of the form r(u, v).
Example 28. Method according to example 27, characterized in that the scalar function of delay times τ(u, v) is determined by numerical integration of the discrete 2D vector field[ΔᵤτΔᵥτ],
wherein the delay differences Δᵤτ in the a direction or Δᵥτ in the v direction are given by

$${Δ}_{u} τ = \frac{{\hat{d}}_{u}}{c} Δ u or$$

$${Δ}_{v} τ = \frac{{\hat{d}}_{v}}{c} Δ v$$

wherein Δu and Δv each describe discrete increments in the u direction or the a direction,
wherein c describes the sound speed, and
wherein \hat{d}ᵤ and \hat{d}ᵥ are given by the scalar products

$${\hat{d}}_{u} = \hat{d} \cdot {s}_{u} or$$

$${\hat{d}}_{v} = \hat{d} \cdot {s}_{v} ,$$

where \hat{d} respectively describes the standardized direction vector (61) starting from the position vector s=s(u, v)and sᵤ and sᵥ describe tangent vectors to the reference surface (30) S starting from the position vector s=s(u, v), in particular wherein sᵤ and sᵥ are given by the partial derivatives

$${s}_{u} = \frac{\partial s}{\partial u} = [ \frac{\partial x}{\partial u} \frac{\partial y}{\partial u} \frac{\partial z}{\partial u} ] or$$

$${s}_{v} = \frac{\partial s}{\partial v} = [ \frac{\partial x}{\partial v} \frac{\partial y}{\partial v} \frac{\partial z}{\partial v} ] .$$

Example 29. Method according to example 27 or 28, characterized in that the numerical integration method comprises the composite trapezium method, the Simpson method, the Romberg method or the more advanced inverse gradient method.
Example 30. Computer program product for determining delay times τⱼ for operating sound transducers (2) i of at least one sound transducer assembly (1) with a plurality of sound transducers (2) i for generating elementary waves (3) according to the delay times τᵢ for the sonication of at least one audience area (5) characterized in that the computer program product contains or uses means for executing at least one instruction for determining delay times τⱼ for sound transducers j according to at least one of examples 1 to 15 or 16 to 29.
Example 31. A device for sonicating at least one public area (3), comprising at least one sound transducer assembly (1) with a plurality of sound transducers (9), wherein the at least one sound transducer assembly (1) can be operated according to a method according to at least one of the examples 1 to 15.
Example 32. Device according to example 31, wherein the at least one sound transducer assembly (1) and the at least one audience area (3) are geometrically linked to one another by a coordinate system (2) and there is a spatial association between the physical positions of the individual sound transducers (9) in the at least one sound transducer assembly (1) and position vectors s; for determining coordinates in the area of the at least one sound transducer assembly (1), and there is further an association of points of the coordinate system (2) with points in the at least one audience area (5) in accordance with a position vector rᵢ, wherein direction vectors, in particular standardized direction vectors (61),

$${\hat{d}}_{i} = \frac{{r}_{i} - {s}_{i}}{\vert {r}_{i} - {s}_{i} \vert}$$

result in the coordinate system (2),
characterized in that:
a means for controlling the sound radiation of the sound transducers (9), which determines delay times τⱼ for the sound transducers (1) depending on the spatial association of the position vectors sᵢ with the sound transducers (9), with which elementary waves (8) are radiated by the transducers (9), wherein the delay times τⱼ of the sound transducer (9) is respectively chosen such that the local direction (50) of the common wavefront (4) corresponds to the direction of the direction vector, in particular of the standardized direction vector (61)\hat{d}ᵢ, and
a means for associating each sound transducer (9) with a point in the at least one audience area (3) corresponding to a position vector rᵢ so that standardized direction vectors (61)

$${\hat{d}}_{i} = \frac{{r}_{i} - {s}_{i}}{\vert {r}_{i} - {s}_{i} \vert}$$

result, and
a means for determining the delay time τⱼ of the sound transducer (9) so that the local direction (50) of a common wavefront (4) corresponds to the direction of the standardized direction vector (61)\hat{d}ᵢ, wherein in particular the individual sound transducers (9) of the at least one sound transducer assembly (1) each radiate elementary waves (8), which are superposed to form a common wavefront (4), and the at least one sound transducer assembly (1) and the at least one audience area (3) are associated with a common coordinate system (2), in which the positions of the individual sound transducers (9) of the at least one sound transducer assembly (1) and the sound transducer can each be operated with a delay time τⱼ for radiating elementary waves (8).
Example 33. Device according to example 31 or 32, characterized in that the different running times for the sound transducers (9) of the sound transducer assembly (1) are realized using a mechanical or geometric positioning of the sound transducers (9) which are controlled with coherent signals, wherein in particular the signal levels for the respective sound transducer (9) can correspond to the values determined for the original intersection points of the grid.

Further exemplary embodiments are described hereinafter:

The concealment of a sound system behind an acoustically semi-transparent panel leads to absorbed or reflected sound energy, which leads to amplification changes in the audio spectrum. The transfer function (TF) is the frequency-dependent reduction or amplification of the sound level of a sound source as it passes through the panel used to conceal the sound system.

Traditionally, the compensation of the TF of the concealed speaker is achieved by equalizing the average TF over several angles or simply taking the TF on the axis and applying the inverse curve as a profile of an equalization stage. A preliminary assessment of the TF in the anechoic chamber led to the conclusion that the evaluated panel introduced very different amplification variations at different angles for the same frequency.

As a result, the spectral balance in the spectator area would deviate considerably at different angles and distances from the concealed audio module, which reduces the spectral homogeneity. A TF compensation as described above would not be sufficient, but an angle-dependent, spatial transfer function would be required.

Wave field synthesis and 3D audio beamforming technology are based on the high-resolution sensitivity and 3D directivity balloons of the transducers built into the audio module. With the help of 3D audio beamforming algorithms, level and phase manipulation can be used to define individually shaped wavefronts that fully adapt to the spectator area. Moreover, the resulting wavefronts are optimized for spatial and spectral homogeneity based on a reference target curve.

If the compensation of the spatial transfer function becomes a challenge, a solution can be employed to improve the spectral balance in 3D space of concealed audio modules, as is described here.

If an algorithm were aware of the spatial transfer function introduced by the acoustic panel in front of the sound transducer, the optimization and equalization machine would compensate for the effect of the panel in each direction, and not only on the axis, and thereby provide a similar power as if the panel were not present. Changes in the radiation balloon of the sound transducer caused by panel resonances, reflections or acoustic absorption at certain angles would be known in advance and would be partially compensated to achieve the desired spectral profile in the entire hearing range.

The object is to detect the directional balloon of the transducer when it is attached, for example, behind a carbon fiber board.

One possibility is to use a holographic measurement approach to determine the directivity of a speaker. This method uses special solutions of the wave equation (spherical harmonic, Hankel function) to determine the 3D sound pressure of the audio device. Compared to conventional measurement methods, this delivers more comprehensive and accurate measurement data while minimizing costs (e.g. for an expensive measurement space) and measurement time.

The instrument to be checked remains in a fixed position in the center of the scanner. This simplifies the handling of heavy equipment and ensures constant space excitation and thus constant space reflections during the scanning process. The robot arm moves a microphone around the instrument to be tested and detects the sound pressure in the near field.

By scanning along a double layer, a direct sound separation can be employed, for example, which uses additional phase information to detect the direction of the sound wave and which can remove all spatial reflections from the direct sound of the speaker. The measuring system thus delivers accurate free-field data in any environment (e.g. workshop or office).

Thus, the effect of an acoustic panel used to cover the audio module can be evaluated on the basis of an exemplary pair of woofer and tweeter. Since the measurements in the near field do not include signal processing, the spectral power outside the working range of the sound transducer is also shown. The frequency responses of the individual sound transducers with and without acoustic panel are represented in FIG. 12.

The comparison of the acoustic results of both measurements shows a transmission loss in the frequency response close to the axis. In a conventional approach, these frequency responses would serve as the basis for calculating the transmission gain and compensate for this energy loss with a DSP. However, if the off-axial frequency responses are also taken into account, the acoustically semitransparent panel causes further disturbances. There are additional resonances which influence the radiation pattern at certain frequencies, in particular in the range between 2 kHz and 5 Hz. Above f>7 kHz, the measurements show higher transmission losses on the axis than off the axis, resulting in a lower directivity index and slightly larger beam angle when the panel is attached.

The spatial transfer function of the acoustic panel in FIG. 13 shows the angular dependence of the amplification changes across the complete spectrum. The spatial transfer function is the absolute spectral amplification difference between the bare transducer and the same transducer behind the acoustic panel after applying a frequency smoothing of 1 octave and a spatial smoothing of 15 degrees. Spatial smoothing has been applied to prevent isolated artifacts created by the panel used for the measurements from being included in the general compensation for other panels with different characteristics: differences in bracing, stiffness of the panel and in manufacturing or slight differences in the positioning of the panel.

To illustrate the advantage of the 3D audio beamforming approach described here compared to conventional audio solutions, the 3 kHz frequency was used as an example in FIG. 13. The level difference between 0′ (on the axis) and 45° is about 2 dB; therefore, any global spectral correction at 2 kHz would work effectively for one angle, but overcompensate or undercompensate at other angles.

Spatial transmission function differences are difficult to resolve with a single global equalizer. On the other hand, with 3D spectral compensation as part of the optimization engine, the sound converters used for the reproduction of the beam can be spatially balanced individually, resulting in an optimal spectral balance when the listener moves across the spectator area.

Once the transducer balloon data has been corrected with the help of the spatial transfer function of the panel and incorporated into the algorithms as an audio module variant, concealed audio modules can be optimized, simulated and benchmarked.

FIG. 14 shows exemplary transfer functions of an optimized beam with an aperture angle of 120° under different scenarios for different angles (0°, 30° and 60°) at ⅓ octave resolution: a simple audio module (black), the same module and beam configuration, covered with the MDI panel at the front (red), and finally the audio module, covered with the MDI panel and spatially compensated with the algorithms.

FIG. 14 illustrates the different spectral fluctuations at different angles, which can only be solved with individual equalization. The spatial compensation for the acoustic panel was implemented to restore the entire spectral balance of the desired frequency response. Isolated local artifacts or spectral discoloration resulting from panel resonances or reflections were not part of the correction, as their compensation has been shown to be ineffective.

Audio systems can be hidden in several ways. Acoustically transparent materials such as fabric or perforated screens let the sound pass through with minimal loss of acoustic power and can be effective in certain environments.

There may be problems if there are visible distortions when projecting video content. To solve this problem, a high-resolution video projection solution with a microperforated carbon fiber board can be used. This proved to be very effective as it offered a seamless projection surface, but had some disadvantages for the sound system behind it, namely angle-dependent fluctuations of the transfer function.

A near-field scanner system has proven to be an effective and robust method for detecting the directional characteristic of speakers, including those hidden behind a panel. The detection of the three-dimensional behavior of the drivers installed in the audio modules and inserted behind the panel was used for the implementation of the spatial spectral balance correction required data.

Spectral equilibrium correction compensates for the level differences between different angles in 3D space for the same frequency throughout the audio spectrum. This function considerably increased the spectral homogeneity of the audio beams employed and represents a clear advantage over the traditional compensation methods otherwise used.

### REFERENCE NUMERALS

1 sound transducer assembly
2 common coordinate system
3 audience area
4 wavefront formed from elementary waves
5 auxiliary grid on the reference surface of the sound transducer assembly
6 auxiliary grids in the audience area
7 direction vector
8 elementary waves
9 sound transducers
10 supply area of the wavefront
105 partial areas of the wavefront
106 partial areas of the audience area
12 virtual sound source
30 curved sound transducer surface
31 normal
40 cuboid for vector determination
50 local direction of common wavefront
60 standard cuboid with diagonal one
61 standardized direction vector
701,702, 703 partial areas of the audience area
801 used intersection points
802 fixed audience areas
90 mechanically curved sound transducer assembly
91 spatial offset

1. A method for operating and/or setting up a two-dimensional sound transducer assembly (1) with a plurality of discretely controllable sound transducers (9) which are arranged on a planar or curved surface and each generate elementary waves which, according to the principle of wave field synthesis, overlap to form at least one sound wave front, wherein a local propagation direction \hat{d}ᵢ for the at least one sound wave front on at least one first sound transducer (9) of the sound transducer assembly (1) is known or can be determined, characterized in that there is a direction-dependent correction of a direction-dependent frequency response of the sound wave front, wherein the correction comprises a correction of direction-dependent frequency response changes of the individual sound transducers and/or a balance of acoustic obstacles in the signal path or wherein the correction comprises a correction of direction-dependent frequency response changes of the individual sound transducers and/or a balance of acoustic obstacles and a compensation of an air sound insulation in the signal path,
wherein, for the correction of the direction-dependent frequency response changes with the help of spherical or polar coordinates φ and θ, the local radiation direction of each individual elementary wave is determined and stored as data, wherein the data to the local radiation direction of each individual elementary wave deliver a frequency response curve from the relation G(f, φ, θ), which, in an inverse filter Gᵢₙᵥ (f), balance frequency response errors of the corresponding sound transducer in a local radiation direction of the corresponding sound wave front at the correction of the direction-dependent frequency response changes;
wherein the balance of the acoustic obstacles is based on a forward correction of the sound transducers and is compensated by means of an inverse filter with the function Hₙᵢᵥ (f), wherein a difference from the measurement of a polar radiation of the individual sound transducers without the acoustic obstacle to a measurement of the polar radiation with the upstream obstacle is stored and used for the given angles φ and θ;
wherein for the compensation of the air sound insulation, an influence on the frequence response is dependent on relative humidity (in %), air pressure (in kPa) and temperature (in K) and increases with the distance d of the sound transducer to the listener, wherein the compensation of the air sound insulation is by using an inverse filter Aₙᵢᵥ (f).

2. The method according to claim 1, wherein the frequency response of the sound transducer (4) of the sound transducer assembly (1) associated with the respective correction member is determined in the reflection-low space and stored for a plurality of radiation directions, which can be described in particular by means of spherical coordinates φ and θ and the reproduction-side correction device comprises an inverse filter with the function Gᵢₙᵥ(f), which depending on the propagation direction \hat{d}ᵢ of a relevant local wave front (6) balances the corresponding non-linearities in the frequency response of the corresponding sound transducer (4) based on a stored direction-dependent frequency response error of the corresponding sound transducer (4) in the local propagation direction of the relevant wave front, whereby during cooperation with the surrounding sound transducers (4) of the sound transducer assembly (1), the frequency response of the respective radiated local wave front (6) becomes independent from its propagation direction \hat{d}ᵢ, which is why the complete wave front of the sound transducer assembly (1) is linearized for the corresponding channel independent of its propagation direction by applying the method separately for each individual sound transducer of the sound transducer assembly (1) and each individual input channel.

3. The method according to claim 1, wherein the damping of a partially sound-transparent acoustic obstacle in a propagation direction \hat{d}ᵢ of the associated sound wave front is balanced by storing the difference of the stored frequency response of the unhindered radiated local wave front (6) originating in the direction of the propagation direction \hat{d}ᵢ,
and the measured frequency response of the local wave front (6) originating in the direction of the propagation direction \hat{d}ᵢ, radiated by a partially sound-transparent acoustic obstacle for discrete spherical coordinates φ and θ in order to separately correct the amplitude and frequency response of the signal of the associated local wave front (6) during the reproduction depending on the propagation direction \hat{d}ᵢ through an inverse filter with the function Hᵢₙᵥ(f) for each individual sound transducer of the sound transducer assembly (1) and each individual input channel, whereby during cooperation with the surrounding sound transducers the frequency response of the respective radiated wave front becomes independent from its propagation direction \hat{d}ᵢ of the direction-dependent damping of the acoustic obstacle.

4. The method according to claim 1, the acoustic disturbance factor determines air sound insulation in an audience area (2) based on current values for relative humidity (in %), air pressure (in kPa) and temperature (in K) in the audience area (2) and a path length to a spectator area dependent on the direction vector d(3) of the local wave front (6) is balanced correspondingly through a reproduction-side correction device for each individual sound transducer of the sound transducer assembly (1) and each individual input channel separately with an inverse filter with the function Aᵢₙᵥ(f).

5. The method according to claim 1, wherein the order of the correction members in the signal path can be chosen freely and individual correction possibilities can be bridged or omitted.

6. The method according to claim 1, wherein fixed correction values can be stored in the system if the direction of the wave fronts in the system is fixed.

7. The method according to claim 1, wherein systems with a permanently programmed directivity and a permanently programmed direction-dependent correction of the frequency response work autonomously as individual modules or are joined with further modules, which are programmed correspondingly, to form a permanently programmed sound transducer array.

8. The method according to claim 1, wherein a targeted, direction-dependent frequency response change, for example in order to shape certain preferences of individual audience groups or for the correction of hearing losses of individual persons or to expand the artistic possibilities of sound field design, is possible through targeted manipulation of the inverse filters for correction.

9. The method according to claim 1, wherein the data of the compensation filters for each one of the three filter blocks are pre-processed in that they are normalized in a first step in order to change the overall amplification in all directions by a fixed value, to subsequently perform frequency limitation as well as a spatial and spectral smoothing of the data, the smoothing degree of which depends on the required quality of the compensation and the available filter resolution and to finally invert the normalized and smoothed frequency response data for the given angles φ and θ which results in the final inverse filter.

10. The method according to claim 1, wherein the data concerning directional characteristic are stored in the individual modules and can be read from a central memory and overwritten via a data bus in a setup process.

11. The method according to claim 1, wherein for the calculation of the inverse filters Gᵢₙᵥ (f) and/or Hₙᵢᵥ (f) and/or Aₙᵢᵥ (f) data are pre-processed in the sense of standardized, regularized and/or inverted.

12.-13. (canceled)
